(19) United States
(12) Patent Application Publication
(10) Pub. No.: US 2026/0310811 A1
(43) Pub. Date: Oct. 8, 2026

(54) Method, System, and Computer Program Product for Modelling and Governance for Transitive Privileged Access

(71) Applicant: Visa International Service Association, San Francisco, CA (US)

(72) Inventors: Hanlin Chen, Danville, CA (US); Dominique Louis Fedronic, Belmont, CA (US); Aadithya Jerome Prabhakar Francis, Cedar Park, TX (US); Gaurav Miglani, London (GB); Bee Ching Oh, Union City, CA (US)

(21) Appl. No.: 19/478,949

(22) PCT Filed: Apr. 29, 2024
(86) PCT No.: PCT/US2024/026796

§ 371 Date: Oct. 27, 2025

Related U.S. Application Data
(60) Provisional application No. 63/462,756, filed on Apr. 28, 2023.

(51) Int. Cl. G06F 21/62; G06F 21/60

(52) U.S. Cl. CPC G06F 21/6218; G06F 21/604

(57) ABSTRACT

Methods, systems, and computer program products for modelling and governance for transitive privileged access are provided. A method may include receiving potential transitive access data associated with at least one potential transitive access path, receiving privileged access data associated with a plurality of privileged accesses including a current privileged access, and determining a first target privileged access based on the current privileged access, the potential transitive access data, and the privileged access data. The method may also include generating a first directional graph edge from a first graph node associated with the current privileged access to a second graph node associated with the first target privileged access, the first directional graph edge representing a first transitive access path from the first graph node to the second graph node. The method may also include terminating the current privileged access based on the first transitive access path.

### CROSS REFERENCE TO RELATED APPLICATION

The present application claims the benefit of U.S. Provisional Patent Application No. 63/462,756, filed on Apr. 28, 2023, the disclosure of which is hereby incorporated by reference in its entirety.

### BACKGROUND

### 1. Technical Field

This disclosure relates generally to modelling and governance for transitive privileged access and, in non-limiting embodiments or aspects, to methods, systems, and computer program products for modelling and governance for transitive privileged access.

### 2. Technical Considerations

Users may be granted individual privileged access to systems, system owners, and/or administrators. While an instance of privileged access may be explicitly granted, such privileged access may also cause one or more indirect transitive accesses. Indirect transitive accesses are accesses which may not have been explicitly granted and which may be formed through chaining together segments of individual privileged access. For example, in a network of interconnected computing devices, granting a user privileged access to a first computing device may inadvertently cause that user to gain access to one or more other computing devices, even though the user was not explicitly granted access to such other computing devices.

In some instances, it may be difficult to identify transitive accesses because there can be multiple different access paths from a first computing device to a second computing device and/or subsequent computing devices, and data associated with each of the access paths may be stored in separate databases. Further, it may be difficult to track transitive accesses, remediate transitive accesses, predict transitive accesses that result from a newly requested privileged access, etc. As such, the transitive accesses create security issues and increased vulnerabilities for each transitive access, especially when such transitive accesses are unknown to system owners and/or administrators.

### SUMMARY

Accordingly, provided are improved methods, systems, and computer program products for modelling and governance for transitive privileged access.

According to some non-limiting embodiments or aspects, provided is a computer-implemented method for modelling and governance for transitive privileged access. In some non-limiting embodiments or aspects, the computer-implemented method may include receiving potential transitive access data associated with at least one potential transitive access path. In some non-limiting embodiments or aspects, the computer-implemented method may further include receiving privileged access data associated with a plurality of privileged accesses including a current privileged access. In some non-limiting embodiments or aspects, the computer-implemented method may further include determining a first target privileged access based on the current privileged access, the potential transitive access data, and the privileged access data. In some non-limiting embodiments or aspects, the computer-implemented method may further include generating a first directional graph edge from a first graph node associated with the current privileged access to a second graph node associated with the first target privileged access. In some non-limiting embodiments or aspects, the first directional graph edge may represent a first transitive access path from the first graph node to the second graph node. In some non-limiting embodiments or aspects, the computer-implemented method may further include terminating the current privileged access based on the first transitive access path.

In some non-limiting embodiments or aspects, the computer-implemented method may further include determining a second target privileged access based on the first target privileged access, the potential transitive access data, and the privileged access data. In some non-limiting embodiments or aspects, the computer-implemented method may further include generating a second directional graph edge from the second graph node associated with the first target privileged access to a third graph node associated with the second target privileged access. In some non-limiting embodiments or aspects, the second directional graph edge may represent a second transitive access path from the second graph node to the third graph node.

In some non-limiting embodiments or aspects, the second target privileged access may include a current hop privileged access and the third graph node may include a current hop graph node. In some non-limiting embodiments or aspects, the computer-implemented method may further include determining a next hop target privileged access based on the current hop privileged access, the potential transitive access data, and the privileged access data. In some non-limiting embodiments or aspects, the computer-implemented method may further include generating a next hop directional graph edge from the current hop graph node to a next hop graph node associated with the next hop target privileged access. In some non-limiting embodiments or aspects, the next hop directional graph edge may represent a further transitive access path from the current hop graph node to the next hop graph node. In some non-limiting embodiments or aspects, the computer-implemented method may further include setting the next hop target privileged access as the current hop privileged access and the next hop graph node as the current hop graph node. In some non-limiting embodiments or aspects, the computer-implemented method may further include repeating determining the next hop target privileged access and generating the next hop directional graph edge until a termination condition is satisfied.

In some non-limiting embodiments or aspects, a graph may include the first graph node, the second graph node, and the first directional graph edge. In some non-limiting embodiments or aspects, the computer-implemented method may further include generating a report based on the graph.

In some non-limiting embodiments or aspects, terminating the current privileged access may include terminating the current privileged access based on a user input received in response to the report.

In some non-limiting embodiments or aspects, the computer-implemented method may further include generating the potential transitive access data. In some non-limiting embodiments or aspects, generating the potential transitive access data may include mapping a first plurality of access paths based on a plurality of access types from a first computing device to a second computing device and mapping a second plurality of access paths based on a second plurality of access types from the second computing device to at least one third computing device. In some non-limiting embodiments or aspects, the potential transitive access data may be based on the first plurality of paths and the second plurality of paths.

In some non-limiting embodiments or aspects, a user associated with the current privileged access may have a first role, and the computer-implemented method may further include querying a database to determine whether a role matching the first role is in a database. In some non-limiting embodiments or aspects, the computer-implemented method may further include adding the first role to the database based on determining that the role matching the first role is not in the database.

In some non-limiting embodiments or aspects, the computer-implemented method may further include generating the second graph node. In some non-limiting embodiments or aspects, the computer-implemented method may further include generating a data record associated with the second graph node. In some non-limiting embodiments or aspects, the data record for the second graph node may include an access type associated with the first target privileged access.

According to some non-limiting embodiments or aspects, provided is a system for modelling and governance for transitive privileged access. In some non-limiting embodiments or aspects, the system may include at least one processor. In some non-limiting embodiments, the at least one processor may be configured to receive potential transitive access data associated with at least one potential transitive access path. In some non-limiting embodiments or aspects, the at least one processor may be further configured to receive privileged access data associated with a plurality of privileged accesses comprising a current privileged access. In some non-limiting embodiments or aspects, the at least one processor may be further configured to determine a first target privileged access based on the current privileged access, the potential transitive access data, and the privileged access data. In some non-limiting embodiments or aspects, the at least one processor may be further configured to generate a first directional graph edge from a first graph node associated with the current privileged access to a second graph node associated with the first target privileged access. In some non-limiting embodiments or aspects, the first directional graph edge may represent a first transitive access path from the first graph node to the second graph node. In some non-limiting embodiments or aspects, the at least one processor may be further configured to terminate the current privileged access based on the first transitive access path.

In some non-limiting embodiments or aspects, the at least one processor may be further configured to determine a second target privileged access based on the first target privileged access, the potential transitive access data, and the privileged access data. In some non-limiting embodiments or aspects, the at least one processor may be further configured to generate a second directional graph edge from the second graph node associated with the first target privileged access to a third graph node associated with the second target privileged access. In some non-limiting embodiments or aspects, the second directional graph edge may represent a second transitive access path from the second graph node to the third graph node.

In some non-limiting embodiments or aspects, the second target privileged access may include a current hop privileged access and the third graph node may include a current hop graph node. In some non-limiting embodiments or aspects, the at least one processor may be further configured to determine a next hop target privileged access based on the current hop privileged access, the potential transitive access data, and the privileged access data. In some non-limiting embodiments or aspects, the at least one processor may be further configured to generate a next hop directional graph edge from the current hop graph node to a next hop graph node associated with the next hop target privileged access. In some non-limiting embodiments or aspects, the next hop directional graph edge may represent a further transitive access path from the current hop graph node to the next hop graph node. In some non-limiting embodiments or aspects, the at least one processor may be further configured to set the next hop target privileged access as the current hop privileged access and the next hop graph node as the current hop graph node. In some non-limiting embodiments or aspects, the at least one processor may be further configured to repeat determining the next hop target privileged access and generating the next hop directional graph edge until a termination condition is satisfied.

In some non-limiting embodiments or aspects, a graph may comprise the first graph node, the second graph node, and the first directional graph edge. In some non-limiting embodiments or aspects, the at least one processor may be further configured to generate a report based on the graph.

In some non-limiting embodiments or aspects, when terminating the current privileged access, the at least one processor may be further configured to terminate the current privileged access based on a user input received in response to the report.

In some non-limiting embodiments or aspects, the at least one processor may be further configured to generate the potential transitive access data. In some non-limiting embodiments or aspects, when generating the potential transitive access data, the at least one processor may be configured to map a first plurality of access paths based on a plurality of access types from a first computing device to a second computing device and map a second plurality of access paths based on a second plurality of access types from the second computing device to at least one third computing device. In some non-limiting embodiments or aspects, the potential transitive access data may be based on the first plurality of paths and the second plurality of paths.

In some non-limiting embodiments or aspects, a user associated with the current privileged access may have a first role. In some non-limiting embodiments or aspects, the at least one processor may be further configured to query a database to determine whether a role matching the first role is in a database. In some non-limiting embodiments or aspects, the at least one processor may be further configured to add the first role to the database based on determining that the role matching the first role is not in the database.

In some non-limiting embodiments or aspects, the at least one processor may be further configured to generate the second graph node. In some non-limiting embodiments or aspects, the at least one processor may be further configured to generate a data record associated with the second graph node. In some non-limiting embodiments or aspects, the data record for the second graph node may include an access type associated with the first target privileged access.

According to some non-limiting embodiments or aspects, provided is a computer program product for modelling and governance for transitive privileged access. The computer program product may include at least one non-transitory computer-readable medium including instructions that, when executed by at least one processor, cause the at least one processor to receive potential transitive access data associated with at least one potential transitive access path. In some non-limiting embodiments or aspects, the instructions may further cause the at least one processor to receive privileged access data associated with a plurality of privileged accesses comprising a current privileged access. In some non-limiting embodiments or aspects, the instructions may further cause the at least one processor to determine a first target privileged access based on the current privileged access, the potential transitive access data, and the privileged access data. In some non-limiting embodiments or aspects, the instructions may further cause the at least one processor to generate a first directional graph edge from a first graph node associated with the current privileged access to a second graph node associated with the first target privileged access. In some non-limiting embodiments or aspects, the first directional graph edge may represent a first transitive access path from the first graph node to the second graph node. In some non-limiting embodiments or aspects, the instructions may further cause the at least one processor to terminate the current privileged access based on the first transitive access path.

In some non-limiting embodiments or aspects, the instructions may further cause the at least one processor to determine a second target privileged access based on the first target privileged access, the potential transitive access data, and the privileged access data. In some non-limiting embodiments or aspects, the instructions may further cause the at least one processor to generate a second directional graph edge from the second graph node associated with the first target privileged access to a third graph node associated with the second target privileged access. In some non-limiting embodiments or aspects, the second directional graph edge may represent a second transitive access path from the second graph node to the third graph node.

In some non-limiting embodiments or aspects, the second target privileged access may include a current hop privileged access and the third graph node may include a current hop graph node. In some non-limiting embodiments or aspects, the instructions may further cause the at least one processor to determine a next hop target privileged access based on the current hop privileged access, the potential transitive access data, and the privileged access data. In some non-limiting embodiments or aspects, the instructions may further cause the at least one processor to generate a next hop directional graph edge from the current hop graph node to a next hop graph node associated with the next hop target privileged access. In some non-limiting embodiments or aspects, the next hop directional graph edge may represent a further transitive access path from the current hop graph node to the next hop graph node. In some non-limiting embodiments or aspects, the instructions may further cause the at least one processor to set the next hop target privileged access as the current hop privileged access and the next hop graph node as the current hop graph node. In some non-limiting embodiments or aspects, the instructions may further cause the at least one processor to repeat determining the next hop target privileged access and generating the next hop directional graph edge until a termination condition is satisfied.

In some non-limiting embodiments or aspects, a graph may include the first graph node, the second graph node, and the first directional graph edge. In some non-limiting embodiments or aspects, the instructions may further cause the at least one processor to generate a report based on the graph.

In some non-limiting embodiments or aspects, when terminating the current privileged access, the instructions may further cause the at least one processor to terminate the current privileged access based on a user input received in response to the report.

In some non-limiting embodiments or aspects, the instructions may further cause the at least one processor to generate the potential transitive access data. In some non-limiting embodiments or aspects, when generating the potential transitive access data, the instructions may further cause the at least one processor to map a first plurality of access paths based on a plurality of access types from a first computing device to a second computing device and map a second plurality of access paths based on a second plurality of access types from the second computing device to at least one third computing device. In some non-limiting embodiments or aspects, the potential transitive access data may be based on the first plurality of paths and the second plurality of paths.

In some non-limiting embodiments or aspects, a user associated with the current privileged access may have a first role. In some non-limiting embodiments or aspects, the instructions may further cause the at least one processor to query a database to determine whether a role matching the first role is in a database. In some non-limiting embodiments or aspects, the instructions may further cause the at least one processor to add the first role to the database based on determining that the role matching the first role is not in the database.

In some non-limiting embodiments or aspects, the instructions may further cause the at least one processor to generate the second graph node. In some non-limiting embodiments or aspects, the instructions may further cause the at least one processor to generate a data record associated with the second graph node. In some non-limiting embodiments or aspects, the data record for the second graph node may include an access type associated with the first target privileged access.

Further non-limiting embodiments or aspects will be set forth in the following numbered clauses:

Clause 1: A computer-implemented method comprising: receiving, with at least one processor, potential transitive access data associated with at least one potential transitive access path; receiving, with at least one processor, privileged access data associated with a plurality of privileged accesses comprising a current privileged access; determining, with at least one processor, a first target privileged access based on the current privileged access, the potential transitive access data, and the privileged access data; generating, with at least one processor, a first directional graph edge from a first graph node associated with the current privileged access to a second graph node associated with the first target privileged access, the first directional graph edge representing a first transitive access path from the first graph node to the second graph node; and terminating, with at least one processor, the current privileged access based on the first transitive access path.

Clause 2: The computer-implemented method of clause 1, further comprising: determining, with at least one processor, a second target privileged access based on the first target privileged access, the potential transitive access data, and the privileged access data; and generating, with at least one processor, a second directional graph edge from the second graph node associated with the first target privileged access to a third graph node associated with the second target privileged access, the second directional graph edge representing a second transitive access path from the second graph node to the third graph node.

Clause 3: The computer-implemented method of clause 1 or 2, wherein the second target privileged access comprises a current hop privileged access and the third graph node comprises a current hop graph node, the method further comprising: determining, with at least one processor, a next hop target privileged access based on the current hop privileged access, the potential transitive access data, and the privileged access data; generating, with at least one processor, a next hop directional graph edge from the current hop graph node to a next hop graph node associated with the next hop target privileged access, the next hop directional graph edge representing a further transitive access path from the current hop graph node to the next hop graph node; setting, with at least one processor, the next hop target privileged access as the current hop privileged access and the next hop graph node as the current hop graph node; and repeating, with at least one processor, determining the next hop target privileged access and generating the next hop directional graph edge until a termination condition is satisfied.

Clause 4: The computer-implemented method of any of clauses 1-3, wherein a graph comprises the first graph node, the second graph node, and the first directional graph edge, the method further comprising: generating, with at least one processor, a report based on the graph.

Clause 5: The computer-implemented method of any of clauses 1-4, wherein terminating the current privileged access comprises terminating the current privileged access based on a user input received in response to the report.

Clause 6: The computer-implemented method of any of clauses 1-5, further comprising: generating, with at least one processor, the potential transitive access data, wherein generating the potential transitive access data comprises: mapping a first plurality of access paths based on a plurality of access types from a first computing device to a second computing device; and mapping a second plurality of access paths based on a second plurality of access types from the second computing device to at least one third computing device, wherein the potential transitive access data is based on the first plurality of paths and the second plurality of paths.

Clause 7: The computer-implemented method of any of clauses 1-6, wherein a user associated with the current privileged access has a first role, the method further comprising: querying, with at least one processor, a database to determine whether a role matching the first role is in a database; and adding, with at least one processor, the first role to the database based on determining that the role matching the first role is not in the database.

Clause 8: The computer-implemented method of any of clauses 1-7, further comprising: generating, with at least one processor, the second graph node; and generating, with at least one processor, a data record associated with the second graph node, the data record for the second graph node comprising an access type associated with the first target privileged access.

Clause 9: A system, comprising: at least one processor configured to: receive potential transitive access data associated with at least one potential transitive access path; receive privileged access data associated with a plurality of privileged accesses comprising a current privileged access; determine a first target privileged access based on the current privileged access, the potential transitive access data, and the privileged access data; generate a first directional graph edge from a first graph node associated with the current privileged access to a second graph node associated with the first target privileged access, the first directional graph edge representing a first transitive access path from the first graph node to the second graph node; and terminate the current privileged access based on the first transitive access path.

Clause 10: The system of clause 9, wherein the at least one processor is further configured to: determine a second target privileged access based on the first target privileged access, the potential transitive access data, and the privileged access data; and generate a second directional graph edge from the second graph node associated with the first target privileged access to a third graph node associated with the second target privileged access, the second directional graph edge representing a second transitive access path from the second graph node to the third graph node.

Clause 11: The system of clause 9 or 10, wherein the second target privileged access comprises a current hop privileged access and the third graph node comprises a current hop graph node, wherein the at least one processor is further configured to: determine a next hop target privileged access based on the current hop privileged access, the potential transitive access data, and the privileged access data; generate a next hop directional graph edge from the current hop graph node to a next hop graph node associated with the next hop target privileged access, the next hop directional graph edge representing a further transitive access path from the current hop graph node to the next hop graph node; set the next hop target privileged access as the current hop privileged access and the next hop graph node as the current hop graph node; and repeat determining the next hop target privileged access and generating the next hop directional graph edge until a termination condition is satisfied.

Clause 12: The system of any of clauses 9-11, wherein a graph comprises the first graph node, the second graph node, and the first directional graph edge, wherein the at least one processor is further configured to: generate a report based on the graph.

Clause 13: The system of any of clauses 9-12, wherein, when terminating the current privileged access, the at least one processor is configured to terminate the current privileged access based on a user input received in response to the report.

Clause 14: The system of any of clauses 9-13, wherein the at least one processor is further configured to: generate the potential transitive access data, wherein, when generating the potential transitive access data, the at least one processor is configured to: map a first plurality of access paths based on a plurality of access types from a first computing device to a second computing device; and map a second plurality of access paths based on a second plurality of access types from the second computing device to at least one third computing device, wherein the potential transitive access data is based on the first plurality of paths and the second plurality of paths.

Clause 15: The system of any of clauses 9-14, wherein a user associated with the current privileged access has a first role, and wherein the at least one processor is further configured to: query a database to determine whether a role matching the first role is in a database; and add the first role to the database based on determining that the role matching the first role is not in the database.

Clause 16: The system of any of clauses 9-15, wherein the at least one processor is further configured to: generate the second graph node; and generate a data record associated with the second graph node, the data record for the second graph node comprising an access type associated with the first target privileged access.

Clause 17: A computer program product comprising at least one non-transitory computer-readable medium including instructions that, when executed by at least one processor, cause the at least one processor to: receive potential transitive access data associated with at least one potential transitive access path; receive privileged access data associated with a plurality of privileged accesses comprising a current privileged access; determine a first target privileged access based on the current privileged access, the potential transitive access data, and the privileged access data; generate a first directional graph edge from a first graph node associated with the current privileged access to a second graph node associated with the first target privileged access, the first directional graph edge representing a first transitive access path from the first graph node to the second graph node; and terminate the current privileged access based on the first transitive access path.

Clause 18: The computer program product of clause 17, wherein the instructions further cause the at least one processor to: determine a second target privileged access based on the first target privileged access, the potential transitive access data, and the privileged access data; and generate a second directional graph edge from the second graph node associated with the first target privileged access to a third graph node associated with the second target privileged access, the second directional graph edge representing a second transitive access path from the second graph node to the third graph node.

Clause 19: The computer program product of clause 17 or 18, wherein the second target privileged access comprises a current hop privileged access and the third graph node comprises a current hop graph node, and wherein the instructions further cause the at least one processor to: determine a next hop target privileged access based on the current hop privileged access, the potential transitive access data, and the privileged access data; generate a next hop directional graph edge from the current hop graph node to a next hop graph node associated with the next hop target privileged access, the next hop directional graph edge representing a further transitive access path from the current hop graph node to the next hop graph node; set the next hop target privileged access as the current hop privileged access and the next hop graph node as the current hop graph node; and repeat determining the next hop target privileged access and generating the next hop directional graph edge until a termination condition is satisfied.

Clause 20: The computer program product of any of clauses 17-19, wherein a graph comprises the first graph node, the second graph node, and the first directional graph edge, and wherein the instructions further cause the at least one processor to: generate a report based on the graph.

Clause 21: The computer program product of any of clauses 17-20, wherein, when terminating the current privileged access, the instructions further cause the at least one processor to terminate the current privileged access based on a user input received in response to the report.

Clause 22: The computer program product of any of clauses 17-21, wherein the instructions further cause the at least one processor to: generate the potential transitive access data, wherein, when generating the potential transitive access data, the instructions further cause the at least one processor to: map a first plurality of access paths based on a plurality of access types from a first computing device to a second computing device; and map a second plurality of access paths based on a second plurality of access types from the second computing device to at least one third computing device, wherein the potential transitive access data is based on the first plurality of paths and the second plurality of paths.

Clause 23: The computer program product of any of clauses 17-22, wherein a user associated with the current privileged access has a first role, and wherein the instructions further cause the at least one processor to: query a database to determine whether a role matching the first role is in a database; and add the first role to the database based on determining that the role matching the first role is not in the database.

Clause 24: The computer program product of any of clauses 17-23, wherein the instructions further cause the at least one processor to: generate the second graph node; and generate a data record associated with the second graph node, the data record for the second graph node comprising an access type associated with the first target privileged access.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for modelling and governance for transitive privileged access, according to some non-limiting embodiments or aspects;

FIG. 2 is a diagram of example components of one or more devices of FIG. 1, according to some non-limiting embodiments or aspects;

FIG. 3 is a flow diagram of a method for modelling and governance for transitive privileged access, according to some non-limiting embodiments or aspects;

FIGS. 4A and 4B are example diagrams of an example implementation of a system for modelling and governance for transitive privileged access, according to some non-limiting embodiments or aspects;

FIG. 5 is a diagram of example transitive access role definitions, according to some non-limiting embodiments or aspects;

FIGS. 6A and 6B are diagrams of an implementation of a method for modelling and governance for transitive privileged access, according to some non-limiting embodiments or aspects;

FIG. 7 is a diagram of example access policy repositories and access path query methods, according to some non-limiting embodiments or aspects;

FIGS. 8A-8D are diagrams of an example implementation of systems and methods for modelling and governance for transitive privileged access, according to some non-limiting embodiments or aspects;

FIG. 9 is a swimlane diagram of an example implementation of a method for modelling and governance for transitive privileged access, according to some non-limiting embodiments or aspects; and

FIG. 10 is a flow diagram of a method for modelling and governance for transitive privileged access, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “POS system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers configured to process online payment transactions through webpages, mobile applications, and/or the like.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices. The term “client device,” as used herein, refers to any electronic device that is configured to communicate with one or more servers or remote devices and/or systems. A client device may include a mobile device, a network-enabled appliance (e.g., a network-enabled television, refrigerator, thermostat, and/or the like), a computer, a POS system, and/or any other device or system capable of communicating with a network.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Provided herein are methods, systems, and computer program products for detecting transitive access. Non-limiting embodiments or aspects of the present disclosure may include a method that includes receiving potential transitive access data associated with at least one potential transitive access path. In some non-limiting embodiments or aspects, privileged access data may be received. The privileged access data may be associated with a plurality of privileged accesses comprising a current privileged access. In some non-limiting embodiments or aspects, a first target privileged access may be determined based on the current privileged access, the potential transitive access data, and the privileged access data. In some non-limiting embodiments or aspects, a first directional graph edge may be generated from a first graph node associated with the current privileged access to a second graph node associated with the first target privileged access. In some non-limiting embodiments or aspects, the first directional graph edge may represent a first transitive access path from the first graph node to the second graph node. In some non-limiting embodiments or aspects, the at least one current privileged access may be terminated based on the first transitive access path. The present disclosure improves techniques of modeling and/or governing transitive privileged access by providing a way to quickly and efficiently identify multiple different access paths originating from a first computing device and leading to a second computing device and/or subsequent computing devices.

In some non-limiting embodiments or aspects, potential transitive access data may be generated by mapping a first plurality of access paths based on a plurality of access types from a first computing device to a second computing device and mapping a second plurality of access paths based on a second plurality of access types from the second computing device to at least one third computing device. In some non-limiting embodiments or aspects, the potential transitive access data may be based on the first plurality of paths and the second plurality of paths. In some non-limiting embodiments or aspects, where a user associated with the current privileged access has a first role, a database may be queried to determine whether a role matching the first role is in a database and the first role may be added to the database based on determining that the role matching the first role is not in the database. Additionally, the present disclosure enables automatic identification of transitive access paths that may have been previously unknown. Further, the present disclosure makes it possible to quickly and efficiently track transitive access, remediate transitive access, and/or predict transitive accesses that may result from a newly requested and/or newly granted privileged access. As such, the present disclosure improves security and reduces vulnerabilities to attacks that may have resulted from unauthorized transitive access.

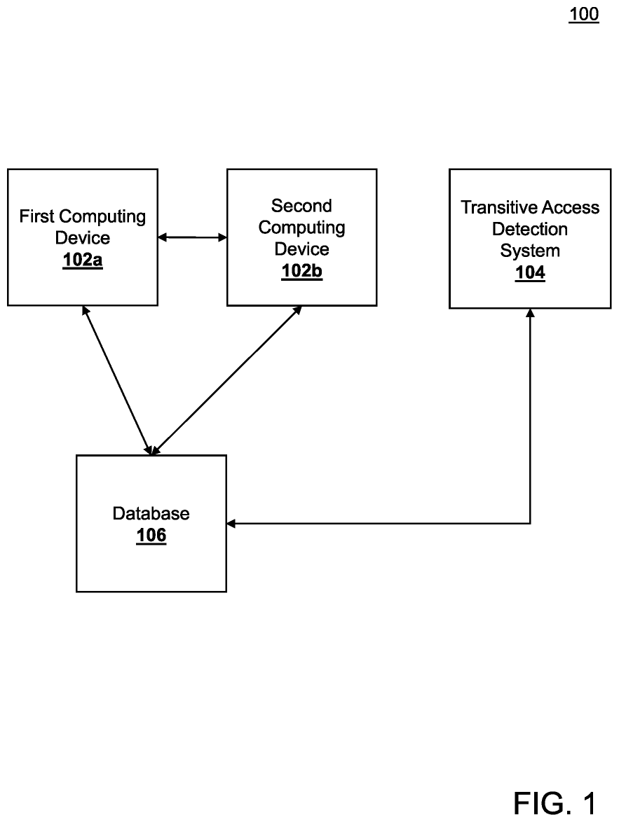

Referring now to FIG. 1, shown is a schematic diagram of a system 100 for modelling and governance for transitive privileged access, according to some non-limiting embodiments or aspects. For example, as shown in FIG. 1, system 100 may include first computing device 102a, second computing device 102b, transitive access detection system 104, and/or database 106. Computing device 102a, second computing device 102b, transitive access detection system 104, and/or database 106 may interconnect (e.g., establish a connection to communicate) via wired connections, wireless connections, or a combination of wired and wireless connections.

First computing device 102a and/or second computing device 102b may include a computing device configured to communicate with transitive access detection system 104 and/or database 106 (e.g., via a wired or wireless connection). For example, first computing device 102a and/or second computing device 102b may include a computing device, such as a server, a desktop computer, a portable computer (e.g., tablet computer, a laptop computer, and/or the like), a mobile device (e.g., a cellular phone, a smartphone, a personal digital assistant, a wearable device, and/or the like), and/or other like devices. In some non-limiting embodiments or aspects, system 100 may include one or more subsequent computing devices that are the same as or similar to first computing device 102a and/or second computing device 102b. In some non-limiting embodiments or aspects, first computing device 102a and/or second computing device 102b may be associated with a transaction service provider system as discussed herein.

Transitive access detection system 104 may include one or more devices configured to communicate with first computing device 102a, second computing device 102b, and/or database 106. For example, transitive access detection system 104 may include at least one computing device, such as a server, a group of servers, and/or other like devices. In some non-limiting embodiments or aspects, transitive access detection system 104 may be associated with a transaction service provider system, as described herein. In some non-limiting embodiments or aspects, transitive access detection system 104 may generate (e.g., train, validate, retrain, and/or the like), store, and/or implement (e.g., operate, provide inputs to and/or outputs from, and/or the like) one or more machine learning models. In some non-limiting embodiments or aspects, transitive access detection system 104 may be in communication with a data storage device (e.g., database 106), which may be local or remote to transitive access detection system 104. In some non-limiting embodiments or aspects, transitive access detection system 104 may be capable of receiving information from, storing information in, transmitting information to, and/or searching information stored in the data storage device (e.g., database 106).

Database 106 may include one or more devices configured to communicate with first computing device 102a, second computing device 102b, and/or transitive access detection system 104 (e.g., via a wired or wireless connection). For example, database 106 may include a computing device, such as a server, a group of servers, and/or other like devices. In some non-limiting embodiments or aspects, database 106 may be associated with a transaction service provider system as discussed herein.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

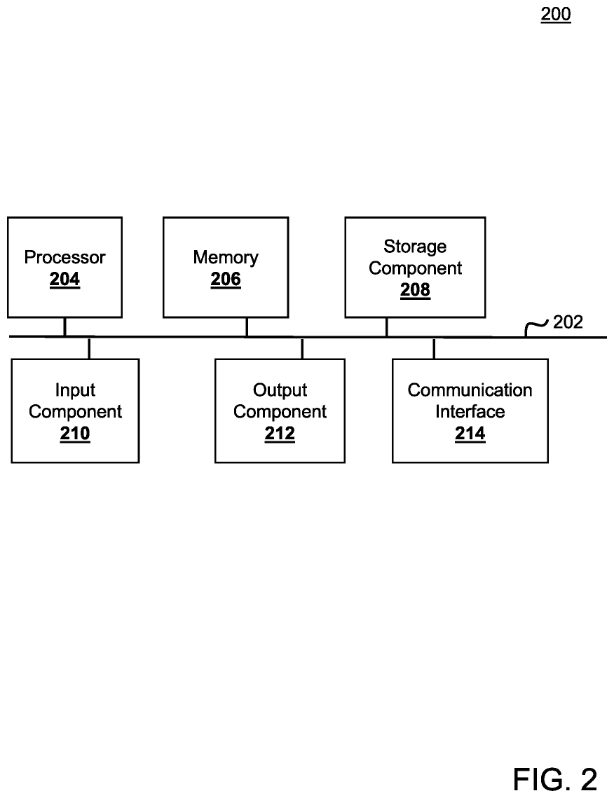

Referring now to FIG. 2, shown is a diagram of example components of a device 200 according to non-limiting embodiments. Device 200 may correspond to first computing device 102a (e.g., one or more devices of first computing device 102a), second computing device 102b (e.g., one or more devices of second computing device 102b), transitive access detection system 104 (e.g., one or more devices of transitive access detection system 104), and/or user database 106, as an example. In some non-limiting embodiments, such systems or devices may include at least one device 200 and/or at least one component of device 200. The number and arrangement of components shown are provided as an example. In some non-limiting embodiments, device 200 may include additional components, fewer components, different components, or differently arranged components than those shown. Additionally, or alternatively, a set of components (e.g., one or more components) of device 200 may perform one or more functions described as being performed by another set of components of device 200.

As shown in FIG. 2, device 200 may include a bus 202, a processor 204, memory 206, a storage component 208, an input component 210, an output component 212, and a communication interface 214. Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

With continued reference to FIG. 2, storage component 208 may store information and/or software related to the operation and use of device 200. For example, storage component 208 may include a hard disk (e.g., a magnetic disk, an optical disk, a magneto-optic disk, a solid-state disk, etc.) and/or another type of computer-readable medium. Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.). Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium may include any non-transitory memory device. A memory device includes memory space located inside of a single physical storage device or memory space spread across multiple physical storage devices. Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

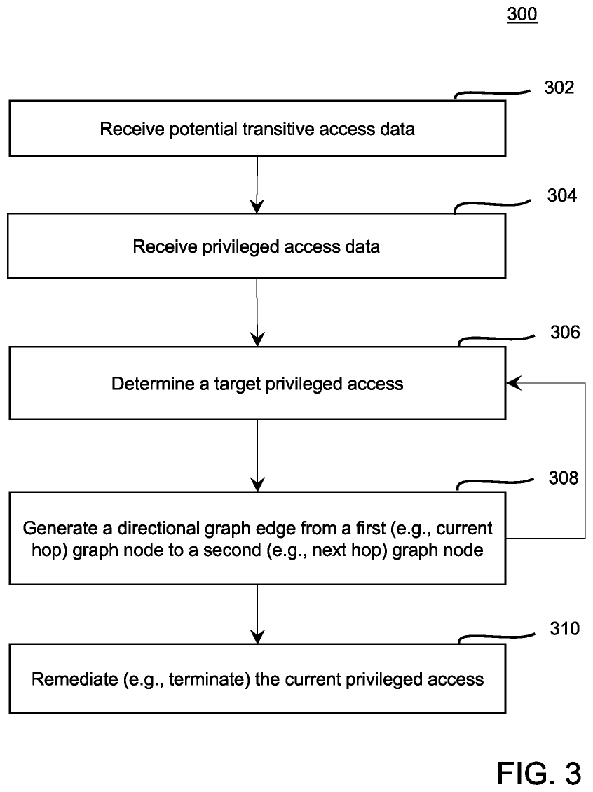

Referring now to FIG. 3, shown is a flow diagram of a method 300 for modelling and governance for transitive privileged access, according to some non-limiting embodiments or aspects. In some non-limiting embodiments or aspects, one or more steps of method 300 may be performed (e.g., completely, partially, etc.) by transitive access detection system 104 (e.g., one or more devices of transitive access detection system 104). In some non-limiting embodiments or aspects, one or more steps of method 300 may be performed (e.g., completely, partially, etc.) by another device or group of devices separate from or including transitive access detection system 104, such as first computing device 102a, second computing device 102b, and/or database 106. The steps shown in FIG. 3 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 3, at step 302, method 300 may include receiving potential transitive access data. For example, transitive access detection system 104 may receive (e.g., from first computing device 102a, second computing device 102b, and/or database 106) potential transitive access data associated with at least one potential transitive access path.

In some non-limiting embodiments or aspects, transitive access detection system 104, first computing device 102a, and/or second computing device 102b may generate the potential transitive access data. In some non-limiting embodiments or aspects, generating the potential transitive access data may include mapping a first plurality of access paths based on a plurality of access types from a first computing device (e.g., first computing device 102a) to a second computing device (e.g., second computing device 102b). Additionally or alternatively, generating the potential transitive access data may include mapping a second plurality of access paths based on a second plurality of access types from the second computing device (e.g., second computing device 102b) to at least one third computing device. The potential transitive access data may be generated based on the first plurality of paths and the second plurality of paths.

In some non-limiting embodiments or aspects, the potential transitive access data may include an access type (e.g., unprivileged, privileged, granted, and/or transitive). In some non-limiting embodiments or aspects, the access path may indicate an access between a first system and/or account and a second system and/or account.

As shown in FIG. 3, at step 304, method 300 may include receiving privileged access data. For example, transitive access detection system 104 may receive (e.g., from first computing device 102a, second computing device 102b, and/or database 106) privileged access data. In some non-limiting embodiments or aspects, the privileged access data may be associated with a plurality of privileged accesses. In some non-limiting embodiments or aspects, the plurality of privileged accesses may comprise a current privileged access.

In some non-limiting embodiments or aspects, a user may be associated with the current privileged access. In some non-limiting embodiments or aspects, the user associated with the current privileged access may be assigned a role (e.g., first role). In some non-limiting embodiments or aspects, transitive access detection system 104 may query a database to determine whether a role matching the user's rule (e.g., the first role) is in the database. For example, transitive access detection system 104 may query database 106 to determine whether a role matching the first role is in database 106. In some non-limiting embodiments or aspects, transitive access detection system 104 may add the first role to the database. For example, transitive access detection system 104 may add the first role to database 106 based on determining that the role matching the first role is not in database 106.

As shown in FIG. 3, at step 306, method 300 may include determining a target privileged access. For example, transitive access detection system 104 may determine a target privileged access. In some non-limiting embodiments or aspects, transitive access detection system 104 may determine a first target privileged access based on the current privileged access, the potential transitive access data, and/or the privileged access data.

In some non-limiting embodiments or aspects, transitive access detection system 104 may determine a second target privileged access based on the first target privileged access, the potential transitive access data, and/or the privileged access data. In some non-limiting embodiments or aspects, the second target privileged access may include a current hop privileged access.

As shown in FIG. 3, at step 308, method 300 may include generating a directional graph edge from a first graph node to a second graph node. For example, transitive access detection system 104 may generate a directional graph edge from a first (e.g., a current hop) graph node to a second (e.g., a next hop) graph node.

In some non-limiting embodiments or aspects, transitive access detection system 104 may generate at least one graph. In some non-limiting embodiments or aspects, the graph may comprise a plurality of nodes and/or a plurality of edges. For example, transitive access detection system 104 may include a plurality of nodes comprising the first graph node and/or the second graph node and/or a plurality of edges comprising the first directional graph edge and/or a second directional graph edge.

In some non-limiting embodiments or aspects, the graph may comprise the first graph node, the second graph node, and the first directional graph edge connecting the first graph node and the second graph node. In some non-limiting embodiments or aspects, the first graph node may be associated with the current privileged access and the second graph node may be associated with the first target privileged access.

In some non-limiting embodiments or aspects, transitive access detection system 104 may generate the first directional graph edge from a first graph node associated with the current privileged access to a second graph node associated with the first target privileged access. The first directional graph edge may represent a first transitive access path from the first graph node to the second graph node.

In some non-limiting embodiments or aspects, transitive access detection system 104 may generate a data record associated with the second graph node. The data record associated with the second graph node may include an access type associated with the first target privileged access.

In some non-limiting embodiments or aspects, transitive access detection system 104 may generate a second directional graph edge from the second graph node associated with the first target privileged access to a third graph node associated with the second target privileged access. In some non-limiting embodiments or aspects, the second directional graph edge may represent a second transitive access path from the second graph node to the third graph node. In some non-limiting embodiments or aspects, the third graph node may (now) include a current hop graph node.

In some non-limiting embodiments or aspects, transitive access detection system 104 may determine a next hop target privileged access based on the current hop privileged access, the potential transitive access data, and/or the privileged access data. In some non-limiting embodiments or aspects, transitive access detection system 104 may generate a next hop directional graph edge from the current hop graph node to a next hop graph node associated with the next hop target privileged access. In some non-limiting embodiments or aspects, the next hop directional graph edge may represent a further transitive access path from the current hop graph node to the next hop graph node. In some non-limiting embodiments or aspects, transitive access detection system 104 may set the next hop target privileged access as the current hop privileged access and the next hop graph node as the current hop graph node. In some non-limiting embodiments or aspects, transitive access detection system 104 may repeat determining the next hop target privileged access and generating the next hop directional graph edge until a termination condition is satisfied. In some non-limiting embodiments or aspects, the termination condition may be a predetermined condition or a condition set by a user. For example, the termination condition may be that no next hop target privileged access can be determined based on the current hop privileged access.

In some non-limiting embodiments or aspects, transitive access detection system 104 may generate a report. For example, transitive access detection system 104 may generate the report based on the graph.

In some non-limiting embodiments or aspects, transitive access detection system 104 may send the report to a user and/or display data associated with the report via a graphical user interface (GUI) on a user device. In some non-limiting embodiments or aspects, the GUI may be an interactive GUI configured to receive a selection and/or an input from a user of the user device.

In some non-limiting embodiments or aspects, remediating the current privileged access may include remediating the current privileged access based on the report and/or based on a user input received (e.g., via the interactive GUI) in response to the report. For example, transitive access detection system 104 may terminate the current privileged access based on a user input received in response to the report.

As shown in FIG. 3, at step 310, method 300 may include remediating the current privileged access. For example, transitive access detection system 104 may remediate (e.g., terminate) the current privileged access. In some non-limiting embodiments or aspects, transitive access detection system 104 may remediate the current privileged access path based on the first transitive access path.

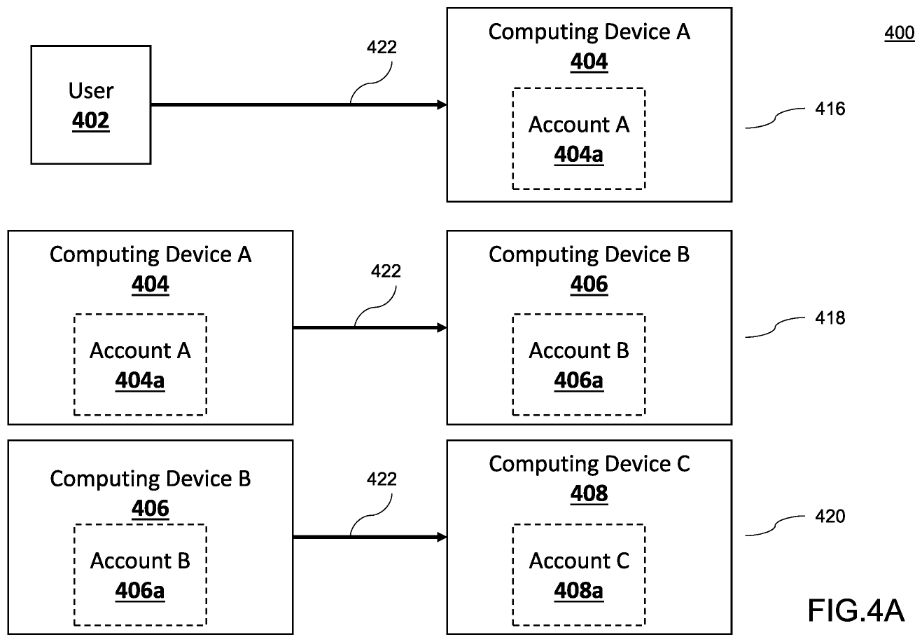

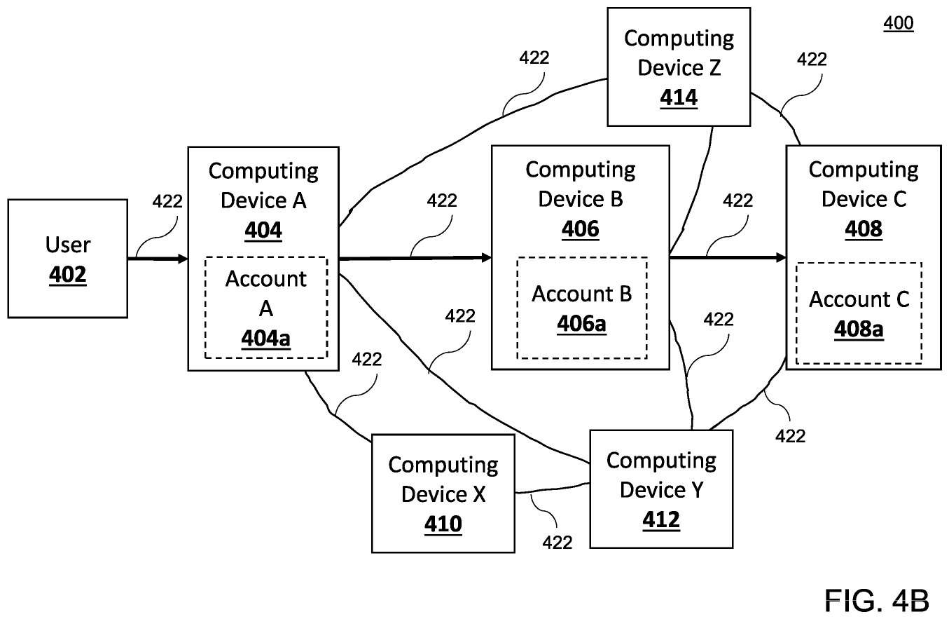

Referring now to FIGS. 4A and 4B, shown are example diagrams of an example implementation of a system 400 for modelling and governance for transitive privileged access, according to some non-limiting embodiments or aspects. System 400 may include user 402, computing device A 404, computing device B 406, computing device C 408, computing device X 410, computing device Y 412, and/or computing device Z 414. In some non-limiting embodiments or aspects, computing device A 404, computing device B 406, and computing device C 408, computing device X 410, computing device Y 412, and/or computing device Z 414 may be the same as, similar to, and/or part of first computing device 102a and/or second computing device 102b.

In some non-limiting embodiments or aspects, each of computing device A 404, computing device B 406, computing device C 408, computing device X 410, computing device Y 412, and/or computing device Z 414 may be associated with a corresponding application permission (App PRMS) data file including App PRMS data including a plurality of App PRMS attributes.

FIG. 4A shows a plurality of privileged access segments 416, 418, and 420. In some non-limiting embodiments or aspects, a privileged access segment may include at least a source and a target system. For example, privileged access segment 416 may include user 402 (e.g., source) and computing device A 404 (e.g., target system). Privileged access segment 418 may include computing device A 404 (e.g., source) and computing device B 406 (e.g., target system). Privileged access segment 420 may include computing device B 406 (e.g., source) and computing device C 408 (e.g., target system). In some non-limiting embodiments or aspects, each of the plurality of privileged access segments 416, 418, and 420 may be managed (e.g., approved, denied, evaluated, re-evaluated, etc.) individually (e.g., separately) based on the App PRMS data file corresponding to the target system. In some non-limiting embodiments or aspects, each of the plurality of privileged access segments may be managed (e.g., governed) in a separate (e.g., different) identity access management (IAM) product and repository.

Privileged access segment 416 may include a privileged access path 422 from user 402 to computing device A 404. In some non-limiting embodiments or aspects, user 402 (e.g., the source) may generate and/or send a first request message to computing device A 404 including a request for privileged access to computing device A 404 and/or account A 404a (e.g., the target). In response to receiving the first request message, computing device A 404 may generate and/or send a first response message including an indication of a grant or a denial of the request for privileged access to user 402 (e.g., the source) based on the App PRMS corresponding to computing device A 404. In some non-limiting embodiments or aspects, computing device A 404 may grant privileged access to user 402 based on the App PRMS corresponding to computing device A 404.

Privileged access segment 418 may include a privileged access path 422 from computing device A 404 to computing device B 406. In some non-limiting embodiments or aspects, computing device A 404 (e.g., the source) may generate and/or send a second request message to computing device B 406 including a request for privileged access to computing device B 406 and/or account B 406a (e.g., the target). In response to receiving the second request message, computing device B 406 may generate and/or send a second response message including an indication of a grant or a denial of the request for privileged access to computing device A 404 (e.g., the source) based on the App PRMS corresponding to computing device B 406. In some non-limiting embodiments or aspects, computing device B 406 may grant privileged access to computing device A 404 based on the App PRMS corresponding to computing device B 406.

Privileged access segment 420 may include a privileged access path 422 from computing device B 406 to computing device C 408. In some non-limiting embodiments or aspects, computing device B 406 (e.g., the source) may generate and/or send a third request message to computing device C 408 including a request for privileged access to computing device C 408 and/or account C 408a (e.g., the target). In response to receiving the third request message, computing device C 408 may generate and/or send a third response message including an indication of a grant or a denial of the request for privileged access to computing device B 406 (e.g., the source) based on the App PRMS corresponding to computing device C 408. In some non-limiting embodiments or aspects, computing device C 408 may grant privileged access to computing device B 406 based on the App PRMS corresponding to computing device C 408.

In some non-limiting embodiments or aspects, each of computing device A 404, computing device B 406, computing device C 408, computing device X 410, computing device Y 412, and/or computing device Z 414 may be associated with a corresponding account. For example, as shown in FIG. 4A, computing device A 404 may be associated with account A 404a, computing device B 406 may be associated with account B 406a, and/or computing device C 408 may be associated with account C 408a. In some non-limiting embodiments or aspects, privileged access to a computing device may include privileged access to an account on the computing device. For example, privileged access to computing device A 404 may include privileged access to account A 404a.

In some non-limiting embodiments or aspects, each of computing device A 404, computing device B 406, computing device C 408, computing device X 410, computing device Y 412, and/or computing device Z 414 may grant a permission, deny a permission, grant privileged access, deny privileged access, evaluate an access, and/or re-evaluate an access.

As shown in 4B, an access path may include an access path 422. An access path may include a single privileged access path 422 and/or may include a transitive access path formed by chaining together at least two privileged access paths 422. Transitive access may include system and/or account access that is not governed by the target system. For example, the plurality of transitive access paths 422 may be formed by chaining together at least two of the plurality of direct privileged access segments 416, 418, and 420. In some non-limiting embodiments or aspects, even though user 402 may only have direct privileged access to computing device A 404 (e.g., the first privileged access segment), user 402 may gain transitive access to computing device B 406 and/or computing device C 408 by chaining together privileged access segment 416, privileged access segment 418, and/or privileged access segment 420.

In some non-limiting embodiments or aspects, chaining together privileged access segments 416, 418, and 420 may generate at least one transitive access path 422. In some non-limiting embodiments or aspects, the at least one transitive access path 422 may include a transitive access path 422 between computing device A 404 and computing device C 408, computing device X 410, computing device Y 412, and/or computing device Z 414 and/or any combination thereof based on privileged access segments 416, 418, and/or 420. In some non-limiting embodiments or aspects, the at least one transitive access path 422 may include a transitive access path 422 between computing device A 404 and computing device C 408, computing device X 410, computing device Y 412, and/or computing device Z 414 and/or any combination thereof based on privileged access segments 416, 418, and/or 420. In some non-limiting embodiments or aspects, the at least one transitive access path 422 may include a transitive access path 422 between computing device B 406 and computing device X 410, computing device Y 412, and/or computing device Z 414 and/or any combination thereof based on privileged access path segments 416, 418, and/or 420. In some non-limiting embodiments or aspects, the at least one transitive access path 422 may include a transitive access path 422 between computing device C 408 and computing device X 410, computing device Y 412, and/or computing device Z 414 and/or any combination thereof based on privileged access segments 416, 418, and/or 420.

In some non-limiting embodiments or aspects, transitive access detection system 104 may generate potential transitive access data by mapping a first plurality of access paths (e.g., privileged access paths 422 and/or transitive access paths 422) based on a plurality of access types (e.g., privileged access and/or transitive access) from a first computing device (e.g., Computing device A 404) to a second computing device (e.g., Computing device B 406). Transitive access detection system 104 may map a second plurality of access paths (e.g., privileged access paths 422 and/or transitive access paths 422) based on a second plurality of access types from the second computing device (e.g., Computing device B 406) to at least one third computing device (e.g., Computing device C 408).

In some non-limiting embodiments or aspects, the potential transitive access data may be generated based on the first plurality of paths and/or the second plurality of paths. In some non-limiting embodiments or aspects, the potential transitive access data may include an access type (e.g., unprivileged, privileged, granted, and/or transitive). The access type may be determined based on the mapping. For example, the access type may be determined based on the mapping of privileged access paths 422 and/or transitive access paths 422.

In some non-limiting embodiments or aspects, transitive access detection system 104 may receive (e.g., form computing device A 404, computing device B 406, computing device C 408, computing device X 410, computing device Y 412, and/or computing device Z 414) potential transitive access data associated with at least one potential transitive access path (e.g., access path 422).

In some non-limiting embodiments or aspects, the potential transitive access data may include application permissions (App PRMS) data for each of computing device A 404, computing device B 406, computing device C 408, computing device X 410, computing device Y 412, and/or computing device Z 414. The App PRMS data may include a plurality of attributes and/or a plurality of definitions. Each attribute of the plurality of attributes may correspond to a unique definition. For example, the App PRMS data may include the plurality of App PRMS attributes and/or definitions shown in Table 1:

TABLE 1

| App PRMS | | |
|---|---|---|
| Attributes | Definition | Notes |
| Permission Set | Unique Identification (ID) | |
| ID | | |
| Permission Set | Name | |
| Name | | |
| Permission Set | Policy description on what | |
| Description | access this entitlement | |
| | provides | |
| Privilege | Pre-determined semantics | Privilege policy |
| | to represent impersonation | triple drives |
| | of root, service account, | approvers |
| | specific playbook/script, or | identification, |
| | application specific, based | previsioning, |
| | on type below | authorization and |
| Privilege Type | Additional fine-grain on | policy enforcement. |
| | privilege above | The privilege |
| Privilege | Specify which domain this | policy trip can be |
| Domain/platform | entitlement belong to. In | multi-value in the |
| | connected apps, this can be | single PRMS. |
| | Unix Enterprise Directory | |
| | (UED), administrative (AD), | |
| | or superuser do (SUDO). | |
| | For enterprise command | |
| | and control tool (ECCT) this | |
| | can be Jenkins, scalable | |
| | run, or any ECCT | |
| | application ID. The | |
| | transitive access policy | |
| | granted should be only | |
| | limited to specific ECCT | |
| | or application. Policy | |
| | enforcement application | |
| | programming interface (API) | |
| | should validate entitlement | |
| | is used in corresponding | |
| | domain. | |
| Privilege Label | Pre-determined semantics | |
| (or level) | to represent different level | |
| | of privileges (Critical, | |
| | High, Medium, Low) | |
| Provision Type | IAM connect app provision, | |
| | or disconnect app manual | |
| | task, or policy in Policy | |
| | Retrieval Point (PRP) | |
| | without provisioning | |
| Permission Set | Entitlement Owner | |
| Owner | | |
| Permission Set | Define the access target | Can be single or |
| application ID | hosts belong to applications | multiple value, |
| | | or “All” for |
| | | horizontal access |
| Permission Set | Define specific environment | |
| Environment | type of application hosts | |
| Type | (such as production, non- | |
| | production hosts) | |
| Permission Set | Define specific environment | |
| Environment | name of application hosts | |
| Name | (such as primary, backup | |
| | site hosts) | |

In some non-limiting embodiments or aspects, the App PRMS data may include a privilege policy triple including a privilege, a privilege type, and a privilege domain of the target system. In some non-limiting embodiments or aspects, transitive access detection system 104 may approve a permission set identification (e.g., permission set ID), generate a prediction (e.g., prevision), generate an authorization, and/or enforce a policy based on the privilege policy triple. In some non-limiting embodiments or aspects, the privilege policy triple may include multiple values for a single permission.

In some non-limiting embodiments, transitive access detection system 104 may model a transitive access path based on a value of the access policy triple. The access policy triple for modelling transitive access may include a corresponding modelling transitive hop and/or PRMS owner assignment, as shown in Table 2:

TABLE 2

| | | Privilege | Modelling | |
|---|---|---|---|---|
| | Privilege | Domain/ | Transitive | PRMS Owner |
| Privilege | Type | Platform | Hop | Assignment |
| Root, service | Run as | Application | Transitive | Corresponding |
| ID name, | | (App. ID) | access to | account owner |
| admin. | | | service | |
| | | | account or | |
| | | | root in | |
| | | | ECCT | |
| Playbook ID | Playbook | Application | Transitive | Target application |
| | | (App. ID) | access to | owner |
| | | | execute | |
| | | | specific | |
| | | | command | |
| | | | as root | |
| | | | ECCT | |
| Root, service | SUDO | Unix | Transitive | Service account |
| ID name | | | access | owner |
| | | | using | |
| | | | SUDO | |
| | | | access | |
| Service | Password | Unix | Transitive | Service account |
| account | | | access | owner |
| name | | | using | |
| | | | service | |
| | | | account | |
| | | | password | |
| | | | login | |
| Secure Shell | SSH Key | Unix | Transitive | Service |
| (SSH) key | | | access | account/SSH key |
| name/service | | | using SSH | owner |
| account | | | key | |
| name | | | | |
| Read, write, | Custom | Custom | Generic | Owner of the |
| or custom | defined | defined | access | custom object |
| defined | objects | scope or | policy | |
| policy | | domain | | |

In some non-limiting embodiments or aspects, App PRMS may be a generic App PRMS including a SUDO Unix platform PRMS with SUDO command as privilege, SUDO as privilege type, and UNIX as privilege domain.

In some non-limiting embodiments or aspects, the access policy triple may be extended to support generic access of any object type (e.g., custom object, custom system), as shown in the last row of Table 2. For example, the access policy triple, modelling transitive hop, and/or PRMS owner assignment may be defined based on the object type for the target system.

In some non-limiting embodiments or aspects, transitive access detection system 104 may receive (e.g., from first computing device 102a, second computing device 102b, and/or database 106) privileged access data associated with a plurality of privileged accesses comprising a current privileged access. In some non-limiting embodiments or aspects, the privileged access data may be associated with a plurality of privileged accesses. In some non-limiting embodiments or aspects, the plurality of privileged accesses may comprise a current privileged access. In some non-limiting embodiments or aspects, a user may be associated with the current privileged access.

In some non-limiting embodiments or aspects, the user associated with the current privileged access may be assigned a first role (e.g., an enterprise role). In some non-limiting embodiments or aspects, transitive access detection system 104 may query database 106 to determine whether a role matching the first role (e.g., the enterprise role) is in the database. In some non-limiting embodiments or aspects, transitive access detection system 104 may add the first role to the database based on determining that the role matching the first role (e.g., the enterprise role) is not in database 106.

In some non-limiting embodiments or aspects, the first role may include a definition. For example, the enterprise role may include an enterprise role definition for the current privileged access. In some non-limiting embodiments or aspects, transitive access detection system 104 may modify the enterprise role definition to include App PRMS and transitive access path attributes. For example, an enterprise role definition may be modified to include an enterprise role attribute and/or definition as shown in Table 3:

TABLE 3

| Enterprise | | |
|---|---|---|
| Role | | |
| Attributes | Definition | Notes |
| Unique ID | Unique ID | |
| Unique Name | | |
| Description | Policy description on | |
| | what access this | |
| | entitlement provides | |
| Accounts | Accounts assigned to | These attributes drive |
| | the enterprise role | approves identification, |
| Entitlements | Entitlement granted to | provisioning, authorization, |
| (AD group) | this role | and policy enforcement. |
| Platform PRMS | Platform access | One App PRMS instance |
| | granted to this role | represents one |
| Application | Indirect, transitive | hop/segment of transitive |
| PRMS | access PRMS | access. |
| Transitive | Optional attribute to | Directed graph data model |
| Path | link to graph object | to represent transitive |
| Identifier | that represent | access network. The |
| | transitive access | identifier is reference to |
| | network | starting node ID in the |
| | | graph database |
| | | implementation |

In some non-limiting embodiments or aspects, an enterprise role for transitive access may include one or more App PRMS. For example, each of the one or more App PRMS may represent a hop in the transition in different IAM access policy repositories, with specific privilege details define by an access policy triple.

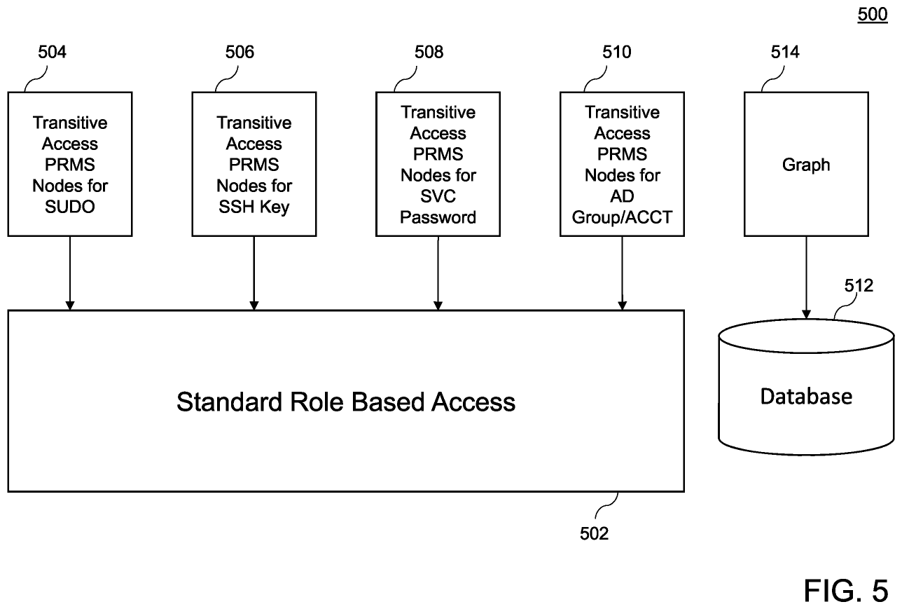

Referring now to FIG. 5, shown is a diagram 500 of example transitive access role definitions, according to some non-limiting embodiments or aspects. Transitive access role definition 500 may include standard role based access 502.

Transitive access detection system 104 may generate and/or receive transitive access PRMS nodes for SUDO 504, transitive access PRMS nodes for Secure Shell (SSH) key 506, transitive access PRMS nodes for service account (SVC) password 508, and/or transitive access PRMS nodes for administrative group/account (AD group/ACCT) 510. In some non-limiting embodiments or aspects, each node of the plurality of nodes may include an App PRMS corresponding to a hop in the transitive access path.

In some non-limiting embodiments or aspects, transitive access detection system 104 may generate standard role based access 502 based on transitive access PRMS nodes for SUDO 504, transitive access PRMS nodes for SSH key 506, transitive access PRMS nodes for service account (SVC) password 508, and/or transitive access PRMS nodes for AD group/ACCT 510. Standard role based access 502 may include the enterprise role. The enterprise role for transitive access may contain app PRMS for SUDO impersonation, SSH key access, service account password access and/or enterprise command and control tool (ECCT) privileged elevation, corresponding to each segment of full end-to-end transitive access.

In some non-limiting embodiments or aspects, each node of the plurality of nodes may correspond to a privileged access segment. For example, one of the first privileged access segment, the second privileged access segment, and/or the third privileged access segment may correspond to transitive access PRMS nodes for SUDO 504, transitive access PRMS nodes for SSH key 506, transitive access PRMS nodes for SVC password 508, and/or transitive access PRMS nodes for AD Group/ACCT 510 may correspond to at least one segment of full end-to-end transitive access.

In some non-limiting embodiments or aspects, transitive access role definition 500 may include graph 514. For example, transitive access detection system 104 may generate graph 514 based on standard role based access 502, transitive access PRMS nodes for SUDO 504, transitive access PRMS nodes for SSH key 506, transitive access PRMS nodes for SVC password 508, and/or transitive access PRMS nodes for AD group/ACCT 510. Graph 514 may include a plurality of nodes and/or a plurality of edges. An edge of the plurality of edges may connect a first node with at least one second node. In some non-limiting embodiments or aspects, the plurality of nodes may represent a plurality of computing devices (e.g., computing device A 404, computing device B 406, computing device C 408, computing device X 410, computing device Y 412, and/or computing device Z 414).

In some non-limiting embodiments or aspects, transitive access detection system 104 may generate a first directional graph edge from a first graph node associated with the current privileged access to a second graph node associated with the first target privileged access. The first directional graph edge may represent a first transitive access path from the first graph node to the second graph node.

In some non-limiting embodiments or aspects, transitive access detection system 104 may generate graph 514 based on the one or more transitive access paths. For example, graph 514 may be generated based on transitive access paths 424. In some non-limiting embodiments or aspects, transitive access detection system 104 may input and/or store graph 514 in database 512. Database 512 may include a transitive access graph database. In some non-limiting embodiments or aspects, database 512 may be the same as, similar to, and/or part of database 106.

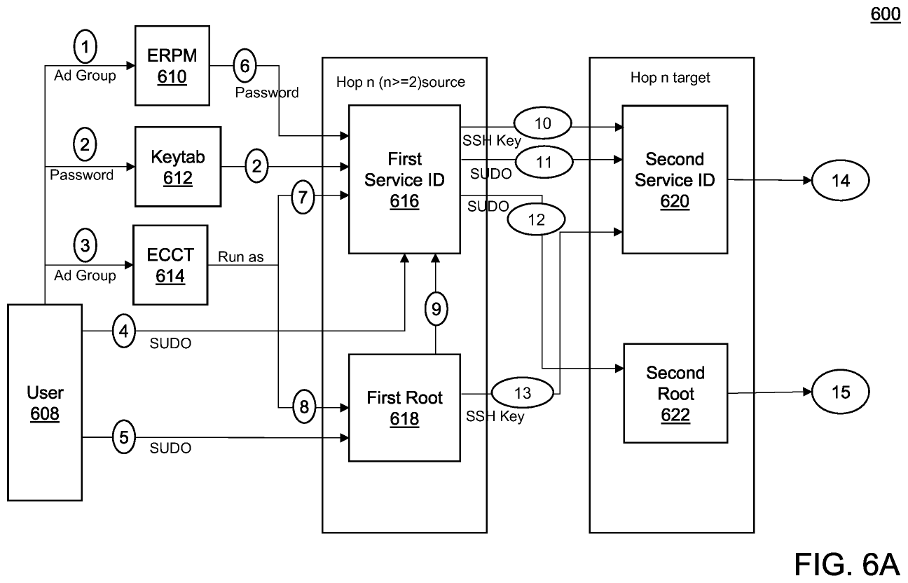

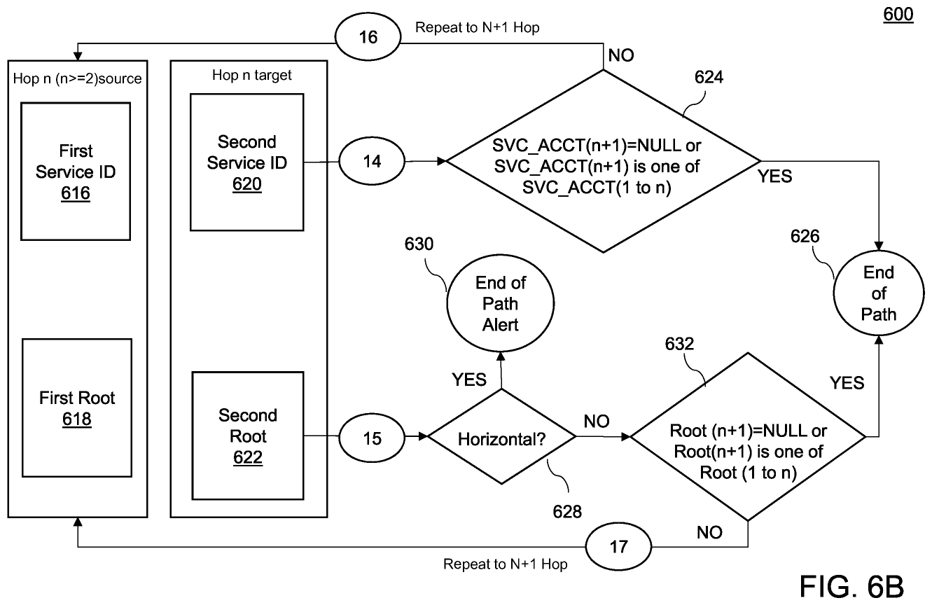

Referring now to FIGS. 6A and 6B, shown are diagrams of an implementation of a method 600 for modelling and governance for transitive privileged access, according to some non-limiting embodiments or aspects. In some non-limiting embodiments or aspects, transitive access detection system 104 may determine one or more transitive access paths based on the transitive access rule(s) illustrated in FIGS. 6A and 6B. In some non-limiting embodiments or aspects, transitive access detection system 104 may determine (e.g., identify) all possible transitive access paths based on enterprise ecosystem and access policies.

As shown in FIG. 6A, diagram 600 includes paths 1-15. In some non-limiting embodiments or aspects, the paths (e.g., paths 1-13) in diagram 600 may correspond to Table 4 below:

TABLE 4

| Path | | Transitive | | |
|---|---|---|---|---|
| No. | Source | Access | Target | Type |
| 1 | User (608) | AD group of | First Service | Hop 1 |
| | | ERPM access | ID (616) | |
| | | | password | |
| 2 | User (608) | AD group of | Key Table | Hop 1 |
| | | ERPM access | (KeyTab) | |
| | | | (First Service | |
| | | | ID (616)) | |
| 3 | User (608) | AD group of | ECCT (614) | Hop 1 |
| | | ECCT access | | |
| 4 | User (608) | SUDO | First Service | Hop 1 |
| | | | ID (616) | |
| 5 | User (608) | SUDO | First Root | Hop 1 |
| | | | (618) | |
| 6 | User (608) | Password | First Service | Hop 2 |
| | | | ID (616) | |
| 7 | User (608) | Run As (AD | First Service | Hop 2 |
| | | Group in | ID (616) | |
| | | ECCT) | | |
| 8 | User (608) | Run As (AD | First Root | Hop 2 |
| | | Group in | (618) | |
| | | ECCT) | | |
| 9 | First Root | SU | First Service | Hop n (n ≥ 2) |
| | (618) | | ID (616) | |
| 10 | First Service | SSH Key | Second | Hop n (n ≥ 2) |
| | ID (616) | | Service ID | |
| | | | (620) | |
| 11 | First Service | SUDO | Second | Hop n (n ≥ 2) |
| | ID (616) | | Service ID | |
| | | | (620) | |
| 12 | First Service | SUDO | Second Root | Hop n (n ≥ 2) |
| | ID (616) | | (622) | |
| 13 | First Root | SSH Key | Second | Hop n (n ≥ 2) |
| | (618) | | Service ID | |
| | | | (620) | |

As shown in Table 4, each path (e.g., paths 1-13) may include a source, a target, a transitive access, and a type (e.g., a hop). In some non-limiting embodiments or aspects, paths 1-13 may represent a direct privileged access path or a transitive access path.

In some non-limiting embodiments or aspects, user 608 may include one or more users of a host. In some non-limiting embodiments or aspects, first service ID 616 may include service accounts and/or hosts associated with a hop n (e.g., SVC_ACCTS(n) on Hosts (n)). In some non-limiting embodiments or aspects, first root 618 may include root privilege on vertical hosts associated with a hop n. In some non-limiting embodiments or aspects, second service ID 620 may include service accounts associated with a next hop (e.g., hop n+1) and/or hosts associated with the next hop (e.g., SVC_ACCTS(n+1) on Hosts (n+1)). In some non-limiting embodiments or aspects, second root 622 may include root privilege on a host associated with the next hop (e.g., hosts (n+1)).

As shown in FIG. 6B, at path 14, transitive access detection system 104 may make a determination at determination block 624. At determination block 624, transitive access detection path 102 may determine whether the service account of the transitive access path from second service ID 620 (e.g., SVC_ACCT(n+1) of second service ID 620) is NULL and/or one of SVC_ACCT(1 to n). If SVC_ACCT(n+1) of second service ID 620 is not NULL and/or if SVC_ACCT(n+1) is not one of SVC_ACCT(1 to n), then transitive access detection system 104 may proceed to follow along path 16. In some non-limiting embodiments or aspects, path 16 may repeat the next hop (n≥2) (e.g., paths 10-13). If SVC_ACCT(n+1) of second service ID 620 is NULL and/or if SVC_ACCT(n+1) is one of SVC_ACCT(1 to n), then transitive access detection system 104 may end at end of path 626.

At path 15, transitive access detection system 104 may make a determination at determination block 628. At determine block 628, transitive access detection system 104 may determine whether a transitive access path is a vertical access path and/or a horizontal access path. In some non-limiting embodiments or aspects, if transitive access detection system 104 determines that the transitive access path from second root 622 is a horizontal path, then transitive access detection system 104 may generate and/or send end of path alert 630. If transitive access detection system 104 determines that the transitive access path from second root 622 is not a horizontal path (e.g., a vertical path), then transitive access detection system 104 may make a determination at determination block 632. In some non-limiting embodiments or aspects, at determination block 632, transitive access detection system 104 may determine whether root (n+1) of second root 622 is NULL and/or one of root (1 to n). If root (n+1) of second root 622 is not NULL and/or if root (n+1) is not one of root (1 to n), then transitive access detection system 104 may procced to follow along path 17. In some non-limiting embodiments or aspects, may repeat path 17 may repeat hop n (n>=2) (e.g., paths 10-13) a number of times to N+1 hop. If root (n+1) of second root 622 is NULL and/or if root (n+1) is one of root (1 to n), then transitive access detection system 104 may end at end of path 626.

In some non-limiting embodiments or aspects, each individual segment may be represented as one hop. In some non-limiting embodiments or aspects, all possible hops may be presented in the transitive path rule data structure in Table 4.

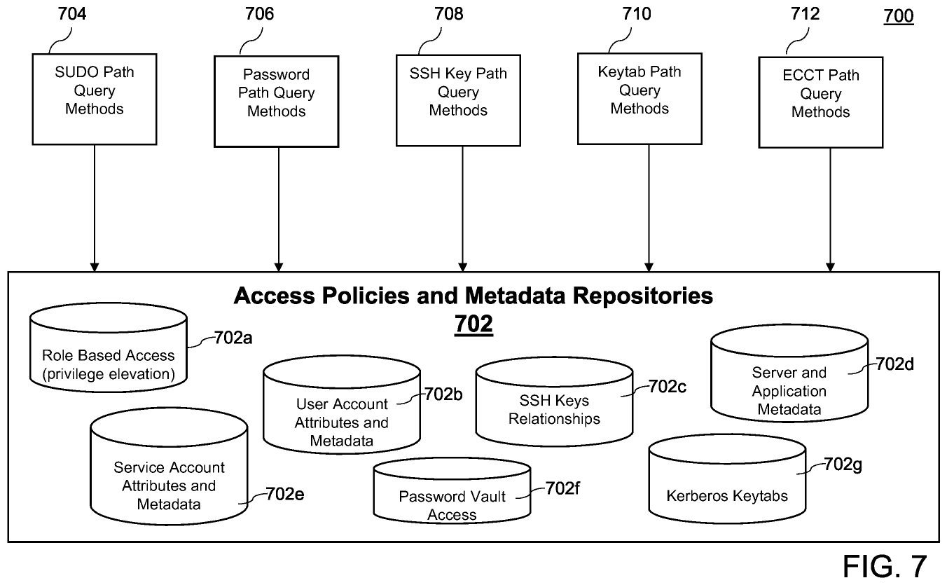

Referring now to FIG. 7, shown is a diagram 700 of example access policy repositories and access path query methods, according to some non-limiting embodiments or aspects. In some non-limiting embodiments or aspects, transitive access detection system 104 may generate and/or store (e.g., in a memory of transitive access detection system 104 and/or in database 106) access policies and metadata repositories 702. In some non-limiting embodiments or aspects, access policies and metadata repositories 702 may include role based access (privilege elevation) 702a, user account attributes and metadata 702b, SSH key relationships 702c, server and application metadata 702d, service account attributes and metadata 702e, password vault access 702f, and/or keytabs 702g (e.g., Kerberos keytabs). In some non-limiting embodiments or aspects, transitive access detection system 104 may generate access policies and metadata repositories 702 based on one or more query methods. For example, transitive access detection system 104 may generate access policies and metadata repositories 702 based on SUDO path query methods 704, password path query methods 706, SSH key oath query methods 708, keytab path query methods 710, and/or ECCT oath query methods 712. In some non-limiting embodiments or aspects, SUDO path query methods 704, password path query methods 706, SSH key oath query methods 708, keytab path query methods 710, and/or ECCT oath query methods 712 may be associated with individual path query data.

In some non-limiting embodiments or aspects, transitive access detection system 104 may generate an access policy repository for each type of individual path. In some non-limiting embodiments or aspects, the query and search methods (e.g., SQL query, function, and/or procedure) may be generated (e.g., defined) and implemented against the policy repository of each individual path.

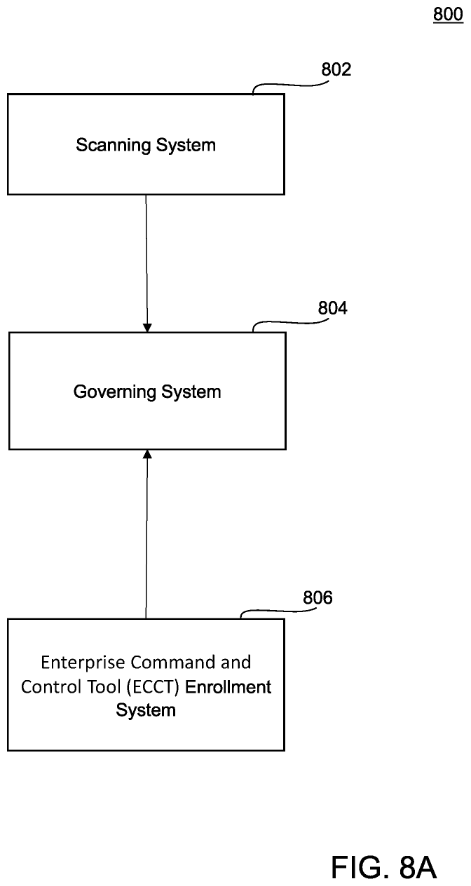

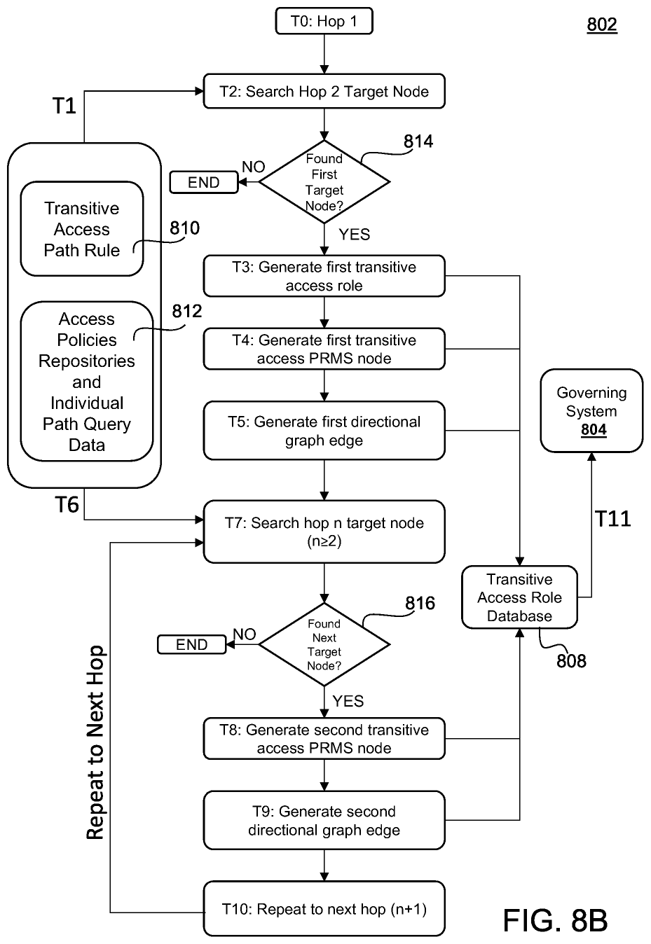

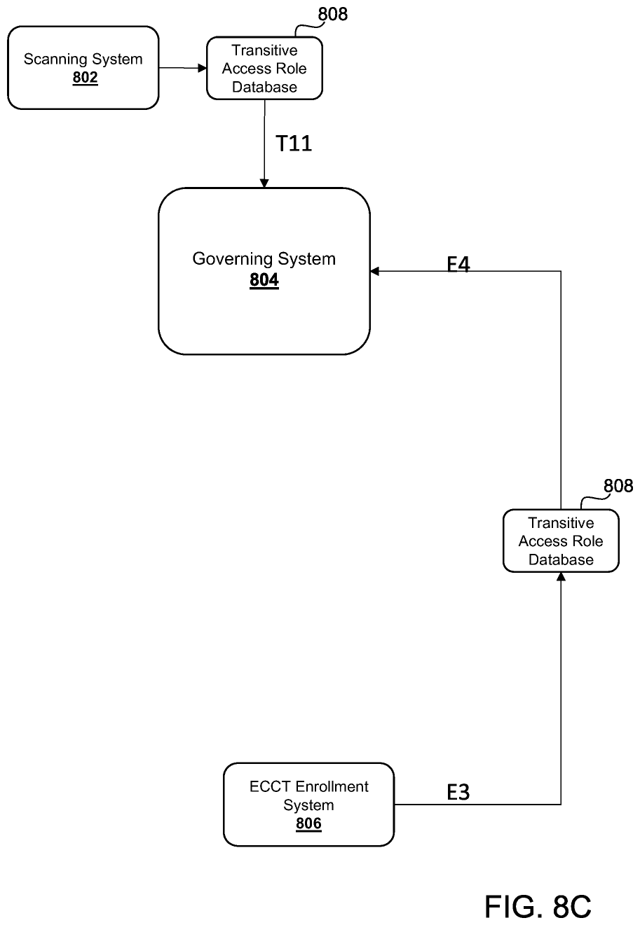

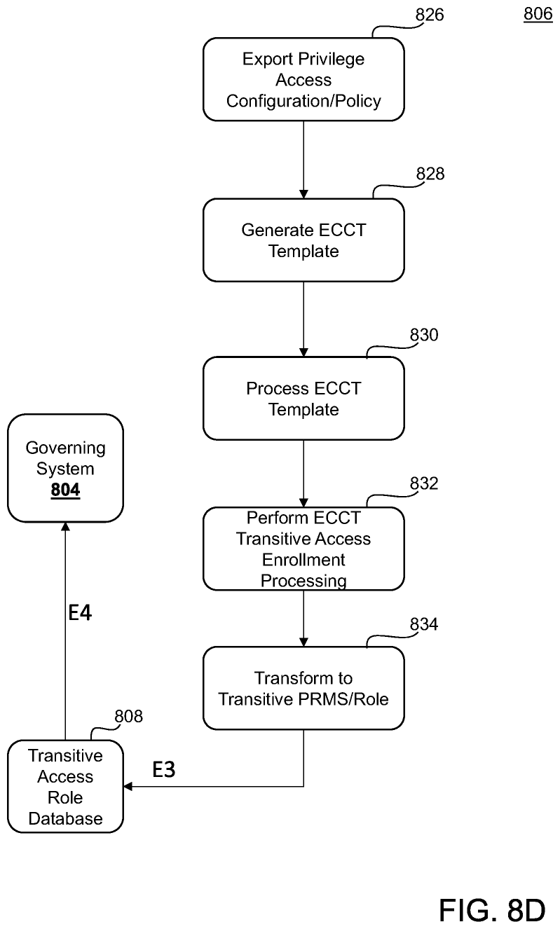

Referring now to FIGS. 8A-8D, shown are diagrams of an example implementation of systems and methods for modelling and governance for transitive privileged access, according to some non-limiting embodiments or aspects. In some non-limiting embodiments or aspects, system 800 may include scanning system 802, governing system 804, and/or enterprise command and control tool (ECCT) enrollment system 806. In some non-limiting embodiments or aspects, scanning system 802, governing system 804, and/or ECCT enrollment system 806 may be the same as, similar to, and/or part of transitive access detection system 104.

In some non-limiting embodiments or aspects, scanning system 802 and/or ECCT enrollment system 806 may output and provide a transitive access role to governing system 804. In some non-limiting embodiments or aspects, governing system 804 may determine whether or not to perform remediation based on receiving the transitive access role.

FIG. 8B shows an example flow of steps (e.g., T0-T11) performed by scanning system 802. In some non-limiting embodiments or aspects, scanning system 802 may perform a scanning process. In some non-limiting embodiments or aspects, scanning system 802 may automatically detect a transitive access path based on performing the scanning process.

In some non-limiting embodiments or aspects, at step T0, scanning system 802 may begin at hop 1.

In some non-limiting embodiments or aspects, at step T1, scanning system 802 may receive potential transitive access data associated with at least one potential transitive access path. In some non-limiting embodiments or aspects, scanning system 802 may receive privileged access data associated with a plurality of privileged accesses comprising a current privileged access. For example, scanning system 802 may receive one or more rules and/or query methods from transitive access path rule 810 and/or access policies and repositories and individual path query data 812. In some non-limiting embodiments or aspects, transitive access path rule 810 and/or individual path query data 812 may be the same as, similar to, and/or part of one or more components of diagram 700.

In some non-limiting embodiments or aspects, at step T2, scanning system 802 may search hop 2 target node. In some non-limiting embodiments or aspects, when searching hop 2 target node scanning system 802 may determine whether or not a target node was found at determination block 814. For example, if scanning system 802 determines that the target node has not been found, then scanning system 802 may end the detection process. If scanning system 802 determines that the target node has been found, then scanning system 802 may proceed to step T3.

In some non-limiting embodiments or aspects, at step T3, scanning system 802 may generate a first target privileged access (e.g., a first transitive access role) based on the current privileged access, the potential transitive access data, and the privileged access data. In some non-limiting embodiments or aspects, scanning system 802 may store the first target privileged access (e.g., the first transitive access role) in transitive access role database 808.

In some non-limiting embodiments or aspects, scanning system 802 may generate a first graph node associated with the current privileged access. In some non-limiting embodiments or aspects, scanning system 802 may store the first graph node in transitive access role database 808.

In some non-limiting embodiments or aspects, at step T4, scanning system 802 may generate a second graph node (e.g., first transitive access PRMS node) associated with the first target privileged access (e.g., the first transitive access role). In some non-limiting embodiments or aspects, scanning system 802 may store the second graph node (e.g., the first transitive access PRMS node) in transitive access role database 808.

In some non-limiting embodiments or aspects, at step T5, scanning system 802 may generate a first directional graph edge from the first graph node associated with the current privileged access to the second graph node associated with the first target privileged access (e.g., the first transitive access PRMS node), the first directional graph edge representing a first transitive access path from the first graph node to the second graph node.

In some non-limiting embodiments or aspects, scanning system 802 may set the first target privileged access as the current hop privileged access and the second graph node as the current hop graph node.

In some non-limiting embodiments or aspects, at step T6, scanning system 802 may receive second potential transitive access data associated with at least one second potential transitive access path. In some non-limiting embodiments or aspects, scanning system 802 may receive second privileged access data associated with a second plurality of privileged accesses comprising the current target privileged access and/or the first target privileged access. For example, scanning system 802 may receive one or more rules and/or query methods from transitive access path rule 810 and/or access policies and repositories and individual path query data 812.

In some non-limiting embodiments or aspects, at step T7, scanning system 802 may search hop n target node, where n is greater than or equal to 2 (e.g., hop n target node (n>=2)). In some non-limiting embodiments or aspects, when searching hop n target node, scanning system 802 may determine whether or not a next (e.g., second) target node was found at determination block 816. For example, if scanning system 802 determines that the target node has not been found, then scanning system 802 may end the detection process. If scanning system 802 determines that the next (e.g., second) target node has been found, then scanning system 802 may proceed to step T8.

In some non-limiting embodiments or aspects, scanning system 802 may generate a second target privileged access (e.g., a second transitive access role) based on the first target privileged access, the second potential transitive access data, and the second privileged access data. In some non-limiting embodiments or aspects, scanning system 802 may store the second target privileged access (e.g., the second transitive access role) in transitive access role database 808. In some non-limiting embodiments or aspects, the second target privileged access may include a current hop privileged access.

In some non-limiting embodiments or aspects, at step T8, scanning system 802 may generate a third node (e.g., second transitive access PRMS node) associated with the second target privileged access (e.g., the second transitive access role). In some non-limiting embodiments or aspects, scanning system 802 may store the third node (e.g., the second transitive access PRMS node) in transitive access role database 808. In some non-limiting embodiments or aspects, the third node may include a current hop node.

In some non-limiting embodiments or aspects, at step T9, scanning system 802 may generate a second directional graph edge from the second node associated with the first privileged access to the third node associated with the second target privileged access (e.g., the second transitive access PRMS node), the second directional graph edge representing a second transitive access path from the second node to the third node.

In some non-limiting embodiments or aspects, scanning system 802 may set the second target privileged access as the current hop privileged access and the third graph node as the current hop graph node.

In some non-limiting embodiments or aspects, at step T10, scanning system 802 may repeat steps T7-T10 recursively to a next hop (e.g., hop n+1).

In some non-limiting embodiments or aspects, scanning system 802 may determine a next hop target privileged access based on the current hop privileged access, the potential transitive access data, and the privileged access data. In some non-limiting embodiments or aspects, scanning system 802 may generate a next hop directional graph edge from the current hop graph node to a next hop graph node associated with the next hop target privileged access, the next hop directional graph edge representing a further transitive access path from the current hop graph node to the next hop graph node. In some non-limiting embodiments or aspects, scanning system 802 may set the next hop target privileged access as the current hop privileged access and the next hop graph node as the current hop graph node. In some non-limiting embodiments or aspects, scanning system 802 may repeat determining the next hop target privileged access and generating the next hop directional graph edge until a termination condition is satisfied.

In some non-limiting embodiments or aspects, scanning system 802 may generate a graph including the first graph node, the second graph node, and the first directional graph edge. In some non-limiting embodiments or aspects, the graph may include the third graph node and/or the second directional graph edge. In some non-limiting embodiments or aspects, scanning system 802 may generate a report based on the graph.

In some non-limiting embodiments or aspects, at step T11, scanning system 802 may provide data (e.g., from transitive access role database 808) to governing system 804.

Referring now to FIG. 8C, shown is a governing system 804 for governing transitive access, according to some non-limiting embodiments or aspects. As shown in FIG. 8C, governing system 804 may input data from transitive access role database 808 into role based access control (RBAC)/permissions processing system 818. For example, governing system 804 may input data associated with a current privilege access, a first target privileged access, a second target privileged access, and/or a next privileged access into governing system 804.

In some non-limiting embodiments or aspects, governing system 804 may include an identity and access management (IAM) governing system. In some non-limiting embodiments or aspects, the IAM governing system may include a role based access control (RBAC)/permission processing system.

In some non-limiting embodiments or aspects, upon receiving transitive access data from transitive access role database 808, governing system 804 may determine whether or not standard RBAC access is approved. In some non-limiting embodiments or aspects, upon receiving transitive access data from transitive access role database 808, governing system 804 may determine whether user access must be revaluated. For example, governing system 804 may determine whether standard RBAC user access should be revaluated based on the transitive access data. In some non-limiting embodiments or aspects, governing system 804 may determine whether or not to perform a type of remediation. For example, governing system 804 may determine to perform a type of remediation based on determining that the standard RBAC access is denied and/or based on determining that revaluation must be performed. In some non-limiting embodiments or aspects, a type of remediation may include termination of a current privileged access based on a transitive access path.

Referring now to FIG. 8D, shown is an example flow of ECCT enrollment system 806. ECCT enrollment system 806 may be used to enroll ECCT transitive access paths into standard RBAC governance. In some non-limiting embodiments or aspects, transitive access paths may be configured using an enterprise command and control tool (ECCT) and managed outside of governing system 804 (e.g., IAM process).

In some non-limiting embodiments or aspects, at step 824, transitive access detection system 104 may export a privilege access configuration and/or policy.

In some non-limiting embodiments or aspects, at step 826, transitive access detection system 104 may generate ECCT template 826 based on the exported privilege access configuration and/or policy. In some non-limiting embodiments or aspects, the template may be a table and/or spreadsheet (e.g., a comma separated values (CSV) file, a tab separated values (TSV) file, and/or the like, based on application permissions (App PRMS) and RBAC specifications). In some non-limiting embodiments or aspects, the ECCT internal configuration on how each Ad group is mapped to a privilege, such as a service account or a root impersonation or a permission to execute a script, may be exported into the ECCT template.

In some non-limiting embodiments or aspects, at step 828, transitive access detection system 104 may process the exported ECCT template. For example, transitive access detection system 104 may import the ECCT template into governing process 804. In some non-limiting embodiments or aspects, transitive access detections system 102 may detect if a new ECCT access and/or a change in ECCT access in the imported template.

In some non-limiting embodiments or aspects, at step 830, transitive access detection system 104 may perform ECCT transitive access enrollment processing on the processed ECCT template. In some non-limiting embodiments or aspects, transitive access detection system 104 may generate and/or update a corresponding ECCT transitive access in an IAM repository.

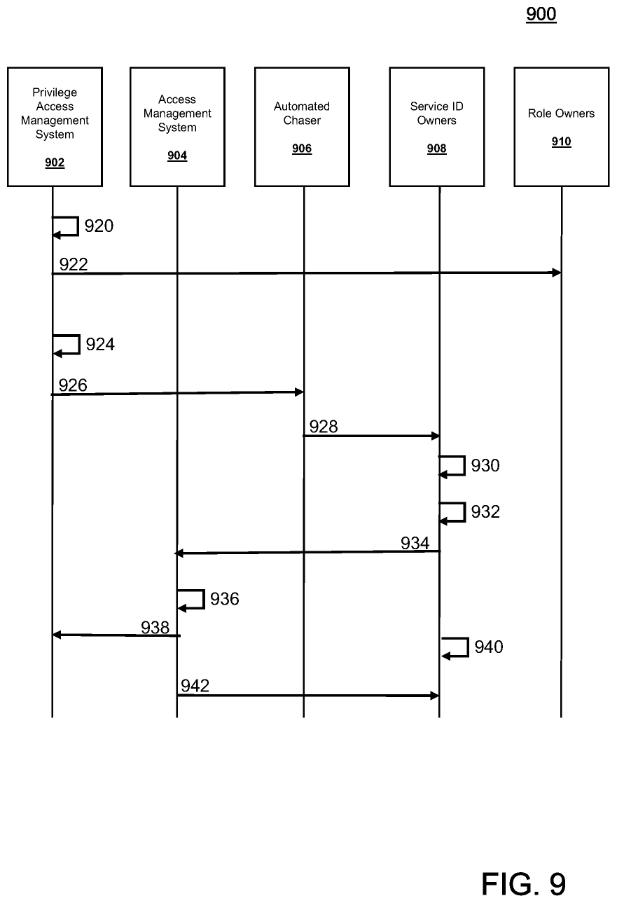

Referring now to FIG. 9, shown is a swimlane diagram 900 of an example implementation of a method for modelling and governance for transitive privileged access, according to some non-limiting embodiments or aspects. In some non-limiting embodiments or aspects, privilege access management system 902, access management system 904, automated chaser 906, service ID owners 908, and/or role owners 910 may be the same as, similar to, and/or part of transitive access detection system 104.

As shown in FIG. 9, at step 920, privileged access management system 902 may extract a list of enterprise roles that provide a user with access (e.g., impersonation) to first service ID (e.g., service ID in the first hop).

At step 922, role owners 910 may receive the list of enterprise roles. In some non-limiting embodiments or aspects, role owner 910 may convert enterprise roles into just-in-time (JIT) roles.

At step 924, privileged access management system 902 may prepare email templates and/or review workbooks.

At step 926, automated chaser 906 may receive the email templates and/or workbooks from privileged access management system 902. In some non-limiting embodiments or aspects, automated chaser 906 may review the email templates, create tasks (e.g., remediation (REM) tasks), and/or trigger a message to be sent (e.g., an email). In some non-limiting embodiments or aspects, automated chaser 906 may send the workbooks to service ID owners 908.

At step 928, service ID owners 908 may review the workbooks received from automated chaser 906.

At step 930, service ID owners 908 may determine whether or not any transitive access has been retained.

In some non-limiting embodiments or aspects, if service ID owners 908 determine that transitive access has not been retained, process 900 may proceed to step 932.

In some non-limiting embodiments or aspects, if service ID 908 determines that transitive access has been retained, process 900 may proceed to step 940. In some non-limiting embodiments or aspects, if service ID 908 determines that transitive access has not been retained, process 900 may proceed to step 932.

At step 932, service ID owners 908 may provide justification data (e.g., business justification on the use-case and requirements) related to service ID's impersonation to a root via RBAC to access management system 904.

In some non-limiting embodiments or aspects, after step 932, process 900 may proceed to step 934. At step 934, access management system 904 may review the justification data received from service ID owners 908.

In some non-limiting embodiments or aspects, after step 934, process 900 may proceed to step 936. At step 936, access management system 904 may determine whether transitive root access is approved.

In some non-limiting embodiments or aspects, if access management system 904 determines that transitive root access is not approved, process 900 may proceed to step 942.

In some non-limiting embodiments or aspects, if access management system 904 determines that transitive root access is approved, process 900 may proceed to step 938. At step 938, privileged access management system 902 may add the service ID to a list (e.g., an allow list) and mark the service ID as approved and/or reviewed in transitive access detection queries. In some non-limiting embodiments or aspects, in response to completing step 8B, process 900 may end.

In some non-limiting embodiments or aspects, at steps 940 and 942, access management system 904 may remove users from roles (e.g., transitive access roles), AD groups, and service ID impersonation access to a root.

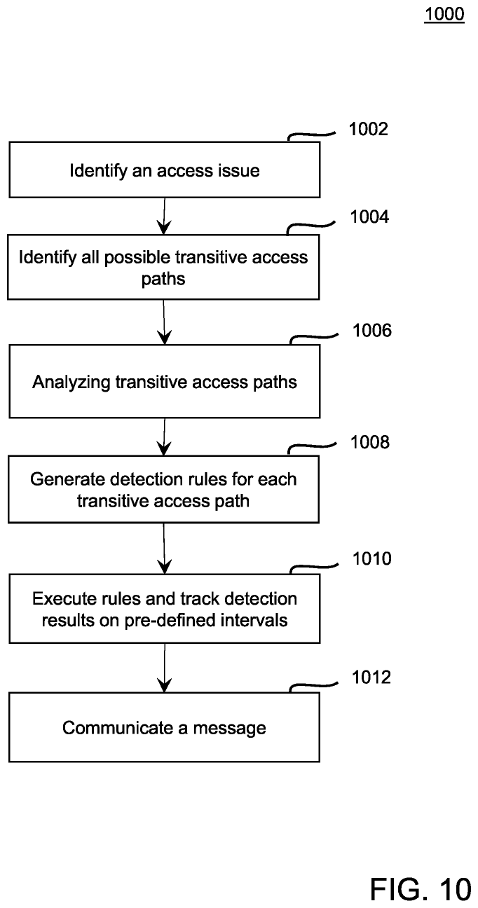

Referring now to FIG. 10, shown is a flow diagram of a method 1000 for modelling and governance for transitive privileged access, according to some non-limiting embodiments or aspects. In some non-limiting embodiments or aspects, one or more steps of method 1000 may be performed (e.g., completely, partially, etc.) by transitive access detection system 104 (e.g., one or more devices of transitive access detection system 104). In some non-limiting embodiments or aspects, one or more steps of method 300 may be performed (e.g., completely, partially, etc.) by another device or group of devices separate from or including transitive access detection system 104, such as first computing device 102a, second computing device 102b, and/or database 106. The steps shown in FIG. 10 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 10, at step 1002, method 1000 may include identifying an issue. For example, transitive access detection system 104 may identify an access issue relating to transitive access between a first computing device (e.g., first computing device 102a) and a second computing device (e.g., second computing device 102b).

As shown in FIG. 10, at step 1004, method 1000 may include identifying all possible transitive access paths. For example, transitive access detection system 104 may identify all transitive access paths between the first computing device and the second computing device in response to identifying the access issue.

As shown in FIG. 10, at step 1006, method 1000 includes analyzing the transitive access paths. For example, transitive access detection system 104 may analyze the transitive access paths (e.g., paths against which detection workflow and logic is required to be built).

As shown in FIG. 10, at step 1008, method 1000 may include generating detection rules for each transitive access path. For example, transitive access detection system 104 may generate detection rules for each transitive access path identified between the first computing device and the second computing device.

In some non-limiting embodiments or aspects, transitive access detection system 104 may retrieve user entitlement data from multiple systems (e.g., role based access (privilege elevation), password vault access, SSH Key relationships, Kerberos keytabs, service account attributes and metadata, user account attributes and metadata, and/or service and application metadata). In some non-limiting embodiments or aspects, transitive access detection system 104 may generate relationships between one or more systems to generate query and logic for staging or intermediary paths. In some non-limiting embodiments or aspects, transitive access detection system 104 may generate one or more rules for each transitive access path identified. In some non-limiting embodiments or aspects, transitive access detection system 104 may generate and/or publish one or more reports based on the transitive access paths identified.

As shown in FIG. 10, at step 1010, method 1000 may include executing rules and tracking detection results on pre-defined intervals. For example, transitive access detection system 104 may execute the one or more rules and track detection results based on pre-defined intervals of time (e.g., real time, substantially real time, hours, days, weeks, months, etc.). In some non-limiting embodiments or aspects, the transitive access paths identified may be monitored by transitive access detection system 104 substantially in real time (e.g., in real time, in near real time, at runtime, while the computing devices are operating, and/or the like).

As shown in FIG. 10, at step 1012, method 1000 may include communicating a message. For example, transitive access detection system 104 may communicate a message. The message may include data associated with one or more of the identified transitive access paths. In some non-limiting embodiments or aspects, transitive access detection system 104 may communicate the message to a governing system (e.g., governing system 804) via an IAM automated notification system. In some non-limiting embodiments or aspects, the governing system (e.g., governing system 804) may review to determine whether to perform remediation or approve the transitive access in response to receiving the message.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method, comprising:
receiving, with at least one processor, potential transitive access data associated with at least one potential transitive access path;
receiving, with at least one processor, privileged access data associated with a plurality of privileged accesses comprising a current privileged access;
determining, with at least one processor, a first target privileged access based on the current privileged access, the potential transitive access data, and the privileged access data;
generating, with at least one processor, a first directional graph edge from a first graph node associated with the current privileged access to a second graph node associated with the first target privileged access, the first directional graph edge representing a first transitive access path from the first graph node to the second graph node; and
terminating, with at least one processor, the current privileged access based on the first transitive access path.

2. The computer-implemented method of claim 1, further comprising:
determining, with at least one processor, a second target privileged access based on the first target privileged access, the potential transitive access data, and the privileged access data; and
generating, with at least one processor, a second directional graph edge from the second graph node associated with the first target privileged access to a third graph node associated with the second target privileged access, the second directional graph edge representing a second transitive access path from the second graph node to the third graph node.

3. The computer-implemented method of claim 2, wherein the second target privileged access comprises a current hop privileged access and the third graph node comprises a current hop graph node, the method further comprising:
determining, with at least one processor, a next hop target privileged access based on the current hop privileged access, the potential transitive access data, and the privileged access data;
generating, with at least one processor, a next hop directional graph edge from the current hop graph node to a next hop graph node associated with the next hop target privileged access, the next hop directional graph edge representing a further transitive access path from the current hop graph node to the next hop graph node;
setting, with at least one processor, the next hop target privileged access as the current hop privileged access and the next hop graph node as the current hop graph node; and
repeating, with at least one processor, determining the next hop target privileged access and generating the next hop directional graph edge until a termination condition is satisfied.

4. The computer-implemented method of claim 1, wherein a graph comprises the first graph node, the second graph node, and the first directional graph edge, the method further comprising:
generating, with at least one processor, a report based on the graph.

5. The computer-implemented method of claim 4, wherein terminating the current privileged access comprises terminating the current privileged access based on a user input received in response to the report.

6. The computer-implemented method of claim 1, further comprising:
generating, with at least one processor, the potential transitive access data, wherein generating the potential transitive access data comprises:
mapping a first plurality of access paths based on a plurality of access types from a first computing device to a second computing device; and
mapping a second plurality of access paths based on a second plurality of access types from the second computing device to at least one third computing device,
wherein the potential transitive access data is based on the first plurality of access paths and the second plurality of access paths.

7. The computer-implemented method of claim 1, wherein a user associated with the current privileged access has a first role, the method further comprising:
querying, with at least one processor, a database to determine whether a role matching the first role is in a database; and
adding, with at least one processor, the first role to the database based on determining that the role matching the first role is not in the database.

8. The computer-implemented method of claim 1, further comprising:
generating, with at least one processor, the second graph node; and
generating, with at least one processor, a data record associated with the second graph node, the data record for the second graph node comprising an access type associated with the first target privileged access.

9. A system, comprising:
at least one processor configured to:
receive potential transitive access data associated with at least one potential transitive access path;
receive privileged access data associated with a plurality of privileged accesses comprising a current privileged access;
determine a first target privileged access based on the current privileged access, the potential transitive access data, and the privileged access data;
generate a first directional graph edge from a first graph node associated with the current privileged access to a second graph node associated with the first target privileged access, the first directional graph edge representing a first transitive access path from the first graph node to the second graph node; and
terminate the current privileged access based on the first transitive access path.

10. The system of claim 9, wherein the at least one processor is further configured to:
determine a second target privileged access based on the first target privileged access, the potential transitive access data, and the privileged access data; and
generate a second directional graph edge from the second graph node associated with the first target privileged access to a third graph node associated with the second target privileged access, the second directional graph edge representing a second transitive access path from the second graph node to the third graph node.

11. The system of claim 10, wherein the second target privileged access comprises a current hop privileged access and the third graph node comprises a current hop graph node, wherein the at least one processor is further configured to:
determine a next hop target privileged access based on the current hop privileged access, the potential transitive access data, and the privileged access data;
generate a next hop directional graph edge from the current hop graph node to a next hop graph node associated with the next hop target privileged access, the next hop directional graph edge representing a further transitive access path from the current hop graph node to the next hop graph node;
set the next hop target privileged access as the current hop privileged access and the next hop graph node as the current hop graph node; and
repeat determining the next hop target privileged access and generating the next hop directional graph edge until a termination condition is satisfied.

12. The system of claim 9, wherein a graph comprises the first graph node, the second graph node, and the first directional graph edge, wherein the at least one processor is further configured to:
generate a report based on the graph.

13. The system of claim 12, wherein, when terminating the current privileged access, the at least one processor is configured to terminate the current privileged access based on a user input received in response to the report.

14. The system of claim 9, wherein the at least one processor is further configured to:
generate the potential transitive access data, wherein, when generating the potential transitive access data, the at least one processor is configured to:
map a first plurality of access paths based on a plurality of access types from a first computing device to a second computing device; and
map a second plurality of access paths based on a second plurality of access types from the second computing device to at least one third computing device,
wherein the potential transitive access data is based on the first plurality of access paths and the second plurality of access paths.

15. The system of claim 9, wherein a user associated with the current privileged access has a first role, and wherein the at least one processor is further configured to:
query a database to determine whether a role matching the first role is in a database; and
add the first role to the database based on determining that the role matching the first role is not in the database.

16. The system of claim 9, wherein the at least one processor is further configured to:
generate the second graph node; and
generate a data record associated with the second graph node, the data record for the second graph node comprising an access type associated with the first target privileged access.

17. A computer program product comprising at least one non-transitory computer-readable medium including program instructions that, when executed by at least one processor, cause the at least one processor to:
receive potential transitive access data associated with at least one potential transitive access path;
receive privileged access data associated with a plurality of privileged accesses comprising a current privileged access;
determine a first target privileged access based on the current privileged access, the potential transitive access data, and the privileged access data;
generate a first directional graph edge from a first graph node associated with the current privileged access to a second graph node associated with the first target privileged access, the first directional graph edge representing a first transitive access path from the first graph node to the second graph node; and
terminate the current privileged access based on the first transitive access path.

18. The computer program product of claim 17, wherein the instructions further cause the at least one processor to:
determine a second target privileged access based on the first target privileged access, the potential transitive access data, and the privileged access data; and
generate a second directional graph edge from the second graph node associated with the first target privileged access to a third graph node associated with the second target privileged access, the second directional graph edge representing a second transitive access path from the second graph node to the third graph node.

19. The computer program product of claim 18, wherein the second target privileged access comprises a current hop privileged access and the third graph node comprises a current hop graph node, and wherein the instructions further cause the at least one processor to:
determine a next hop target privileged access based on the current hop privileged access, the potential transitive access data, and the privileged access data;
generate a next hop directional graph edge from the current hop graph node to a next hop graph node associated with the next hop target privileged access, the next hop directional graph edge representing a further transitive access path from the current hop graph node to the next hop graph node;
set the next hop target privileged access as the current hop privileged access and the next hop graph node as the current hop graph node; and
repeat determining the next hop target privileged access and generating the next hop directional graph edge until a termination condition is satisfied.

20. The computer program product of claim 17, wherein a graph comprises the first graph node, the second graph node, and the first directional graph edge, and wherein the instructions further cause the at least one processor to:
generate a report based on the graph.
